(19) United States
(12) Patent Application Publication
(10) Pub. No.: US 2017/0092959 A1
(43) Pub. Date: Mar. 30, 2017

(54) Catalysts for Bio-Electrochemical Systems

(71) Applicants: Alexey Serov, Albuquerque, NM (US); Plamen Atanassov, Santa Fe, NM (US); Carlo Santoro, Albuquerque, NM (US)

(72) Inventors: Alexey Serov, Albuquerque, NM (US); Plamen Atanassov, Santa Fe, NM (US); Carlo Santoro, Albuquerque, NM (US)

(73) Assignee: STC.UNM, Albuquerque, NM (US)

(21) Appl. No.: 15/310,852

(22) PCT Filed: May 14, 2015
(86) PCT No.: PCT/US2015/030890

§ 371 Date: Nov. 14, 2016

Related U.S. Application Data
(60) Provisional application No. 61/996,813, filed on May 14, 2014.

(51) Int. Cl. H01M 4/90; C02F 1/461; H01M 8/16

(52) U.S. Cl. CPC H01M 4/9008; H01M 8/16; C02F 1/46104; H01M 2004/8689

(57) ABSTRACT

Novel catalysts suitable for use in biological systems and biological systems using these catalysts are described. In particular, the present disclosure provides microbial fuel cells utilizing non-PGM catalysts having a morphology that makes them particularly suitable for use in a microbial fuel cell.

### CROSS-REFERENCE TO RELATED APPLICATIONS

The following application claims benefit of U.S. Provisional Application No. 61996813, entitled “Wastewater Treatment,” filed May 14, 2014, which is hereby incorporated by reference in its entirety.

### GOVERNMENT FUNDING

This invention was made with Government support from the Army Research Office, Award W911NF-12-1-0208. The U.S. government has certain rights in this invention.

### BACKGROUND

Fuel cells are receiving increasing attention as a viable energy-alternative. In general, fuel cells convert electrochemical energy into electrical energy in an environmentally clean and efficient manner. Fuel cells are contemplated as potential energy sources for everything from small electronics to cars and homes. In order to meet different energy requirements, there are a number of different types of fuel cells in existence today, each with varying chemistries, requirements, and uses.

Microbial Fuel Cells (MFCs) are receiving increased attention not just for energy generation applications, but also for applications such as wastewater treatment. As an ultimate goal, MFCs could be used to produce both clean water and clean energy. However, MFCs also present some unique challenges. Current MFCs typically utilize a catalyst to initiate the oxygen reduction reaction (ORR) in the cathode. ORR can occur via either 2e⁻ per O₂ (H₂O₂ pathway) or 4e⁻ per O₂ (H₂O pathway), with the latter pathway being preferred due to the larger number of electrons transferred and the production of H₂O as a final product. Cathode overpotential and catalyst poisoning are substantial problems that lead to dramatic kinetic losses in ORR in both short and long term operations¹. The overpotential is mainly caused by the low catalytic activity of the catalysts in the pH range of 6-8, which is the typical pH range of wastewater.

An effective MFC ORR cathode catalysts must be able to operate effectively under the conditions to which the MFC will be subjected. For example, if the MFC is to be used in a system designed to utilize and treat wastewater, the MFC must be designed to protect the catalyst from the harsh conditions that are frequently found in wastewater, or, the catalyst must be able to operate when exposed to the wastewater. Platinum and activated carbon are currently the most commonly used catalysts in MFC cathodes, but present problems such as high cost of operation, instability and decreased performance over time, and low performance in wastewater conditions. Accordingly, there is a need for inexpensive catalysts that can sustain activity under the conditions presented by wastewater or other biologically-based environments.

### SUMMARY

In the present disclosure, novel non platinum group metal (PGM) catalysts suitable for use in biological systems and biological systems using these catalysts are disclosed. In particular, the present disclosure provides microbial fuel cells utilizing non-PGM catalysts having a morphology that makes them particularly suitable for use in a microbial fuel cell.

### BRIEF DESCRIPTION OF THE DRAWINGS

FIG. 1 is a schematic illustration of a dual chamber microbial fuel cell during the stabilization time.

FIG. 2 is a schematic illustration of a duel chamber microbial fuel cell during cathode linear sweep voltammetry configuration.

FIG. 3 is a SEM image of Fe-AAPyr material synthesized as described herein.

FIG. 4 is a TEm image of Fe-AAPyr material synthesized as described herein.

FIG. 5 is XPS spectra for the Fe-MBZ catalyst.

FIG. 6 is XPS spectra for the Fe-AAPyr catalyst.

FIG. 7 depicts the Cathodes Open Circuit Potentials versus the theoretical OCP value (black squares).

FIG. 8 depicts the Cathodes Open Circuit Potentials versus the overall DCMFCs OCVs.

FIG. 9 depicts single cathodes characterization for Pt, Fe-MBZ, and Fe-AAPyr at pH 6.

FIG. 10 depicts single cathodes characterization for Pt, Fe-MBZ, and Fe-AAPyr at pH 7.5.

FIG. 11 depicts single cathodes characterization for Pt, Fe-MBZ, and Fe-AAPyr at pH 9.

FIG. 12 depicts single cathodes characterization for Pt, Fe-MBZ, and Fe-AAPyr at pH 11.

FIG. 13 depicts the dependence of the cathodes current densities (at 0.2V vs. SHE) from pH.

FIG. 14 depicts DCMFC power generated by different cathodes (pt, MBZ, and AA) at pH 6.

FIG. 15 depicts DCMFC power generated by different cathodes (pt, MBZ, and AA) at pH 7.5.

FIG. 16 depicts DCMFC power generated by different cathodes (pt, MBZ, and AA) at pH 9.

FIG. 17 depicts DCMFC power generated by different cathodes (pt, MBZ, and AA) at pH 11.5.

FIG. 18 depicts the dependence of MFCs maximum power from catholyte pH.

FIG. 19 depicts catalyst utilization for W of energy produced.

FIG. 20 depicts the cost analysis per energy produced.

FIG. 21 is an SEM image of Fe-AAPyr at 100k magnification.

FIG. 22 is an SEM image of Fe-AAPyr at 150k magnification.

FIG. 23 is an TEM image of Fe-AAPyr.

FIG. 24 is a graph showing LSVs of the three types of cathodes investigated: Fe-AAPyr, Pt, and AC in clean conditions.

FIG. 25a is a graph showing Single Electrode Performance in Operating Conditions after 5 days.

FIG. 25b is a graph showing Single Electrode Performance in Operating Conditions after 9 days.

FIG. 25c is a graph showing Single Electrode Performance in Operating Conditions after 13 days.

FIG. 25d is a graph showing a power curve after 5 days of operation.

FIG. 25e is a graph showing a power curve after 9 days of operation.

FIG. 25f is a graph showing a power curve after 13 days of operation.

FIG. 26a depicts biofilm growth on an active carbon cathode.

FIG. 26b depicts biofilm growth on a platinum cathode.

FIG. 26c depicts biofilm growth on an Fe-AAPyr cathode.

FIG. 27 depicts voltage trends over a 16-day experiment. The numbers 1 and 2 indicated the replicates tested.

FIG. 28 depicts a cronoamperometry study with additions of S²⁻.

FIG. 29 depicts current losses in function of the S²⁻ concentration.

FIG. 30 depicts a cronoamperometry study with additions of SO4²⁻.

FIG. 31 depicts current loss as a function of the SO4²⁻ concentration. Dot arrows represent the pollutant input while continuous arrows represent the value considered for that specific pollutant concentration.

### DETAILED DESCRIPTION

According to a general embodiment, the present disclosure provides novel catalysts for bio-electrochemical systems and bio-electrochemical systems using these catalysts. According to various embodiments the catalysts of the present disclosure are able to achieve performance levels higher than platinum under certain environmental conditions.

A typical Dual Chamber Microbial Fuel Cell (DCMFC) includes an anode chamber and a cathode chamber that are separated via a proton exchange membrane or other mechanism for transferring protons from one chamber to the other. The anode chamber includes an anode which typically include a structure that has been colonized with bacteria that are able to oxidize oxidizeable compounds in liquid, such as carbon-containing contaminants found in wastewater in order to produce CO₂, electrons and protons. For the purposes of the present disclosure, the term “wastewater” is intended to mean _any liquid stream containing oxidizable compounds, which includes for example municipal sewage and effluent from industrial processes such as food and beverage manufacturing. The electrons can then be used to power an external device while the protons are transferred to the cathode via, for example, a proton exchange membrane, an anion exchange membrane, a separator, a solid electrolyte or other suitable mechanism. The cathode 14 includes a catalyst that is able to reduce the oxygen and protons to produce water. In a DCMFC, the cathode catalyst is separated from the “fuel” (i.e. the wastewater) and thus is not subjected to the environmental conditions created by the fuel. However, the need for a mechanism to transfer the electrons protons from one chamber to the other increases internal resistance, which may not always be desirable.

In a typical Single Chamber Microbial Fuel Cell (SCMFC) the cathode and anode reside in the same chamber. In this case, the proton exchange membrane is not required, but the cathode is then directly exposed to the fuel (i.e. wastewater).

The catalytic materials of the present disclosure are suitable for use with a cathode in either a single or double chamber microbial fuel cell, including, but not necessarily limited to, MFCs such as those described above. In general, the catalytic materials of the present disclosure can be categorized as members of the metal-nitrogen-carbon (M-N—C), nitrogen-carbon or pure carbon catalyst family. According to some embodiments the catalytic material may be formed using the sacrificial support method described herein.

For the sake of clarity, in the present application the term “catalyst” is used to refer to a final product which catalyzes a desired reaction, including, for example, the type of electrocatalytic reactions required for use in various types of fuel cells. The catalyst may include multiple types of materials, including, for example, catalytic materials, supporting materials (active or inactive), etc.

For the purposes of the present disclosure, the term “catalytic material” is any material which contains an active site that enables catalysis, but which may or may not require the presence of a support when in use. Accordingly, a catalyst may be formed, for example, by decorating a carbon, or other, support with a particulate catalytic material or painting the support with a catalytic material-containing ink.

For the purposes of the present disclosure, the term “sacrificial support” is intended to refer to a material that is included during the synthesis process in order to provide temporary structure but which is mostly or entirely removed during or after the synthesis process in order to produce the final desired product. As described in greater detail below, according to various embodiments, the sacrificial support takes the form of a sacrificial particles (also referred to herein as “sacrificial support particles”.)

According to various embodiments of the sacrificial support-based method, sacrificial support particles are mixed with M-N—C (N—C or C) precursors using any suitable means including, but not necessarily limited to solution-based, slurry-based, or mechanochemical synthesis-based mechanisms in order to coat, deposit, impregnate, infuse, or similarly associate the M-N—C precursors on or in the sacrificial support particles and at least initiate formation of the M-N—C product compound. For the sake of simplicity, unless otherwise specified, the term “coat” is used herein as a catchall phrase to refer to any type of physical association, whether or not the “coating” is complete or partial and whether exclusively external or both internal and external. The resulting mixture is dried, if necessary, subjected to heat treatment, creating a mixture of the catalyst material and the sacrificial support, and the sacrificial support is then removed, resulting in a porous, self-supported catalyst.

For the purposes of the present disclosure, the term “precursor” is used to refer to a compound which participates in a chemical reaction by contributing one or more atoms to a compound or compounds that are formed as the product of the chemical reaction or otherwise contributes to the formation of the product.

For the purposes of the present disclosure, the term “sacrificial particle” is intended to refer to a particulate material that is mixed with precursors during the synthesis process in order to provide temporary structure but which is mostly or entirely removed from the final product.

It will be appreciated that the present disclosure often makes reference to “M-N—C precursors.” It should be understood that such terminology is used to refer to any single or group of precursors which, taken as a whole, contain suitable metal, nitrogen, and carbon atoms which are available for chemical synthesis. Accordingly, an “M-N—C precursor” may refer to a metal-nitrogen-and-carbon-containing precursor; or to a metal-containing precursor and a nitrogen-and-carbon-containing precursor; or a metal-and-nitrogen-containing precursor and a carbon-containing precursor; or a metal-and-carbon-containing precursor and a nitrogen-containing precursor; or a metal-containing precursor, a nitrogen-containing precursor, and carbon-containing precursor, so long as the metal, nitrogen, and carbon, are available for chemical synthesis. Accordingly, while the M-N—C precursors referred to herein are most commonly a combination of a metal precursor (such as a metal salt) and precursors of a nitrogen-and-carbon containing compound, it should be understood that other precursor combinations are possible and contemplated by the present disclosure.

According to various embodiments, the metal may be a transitional metal. Examples of suitable transition metals include, but are not necessarily limited to: Fe, Co, Mn, Zn, Ce, Cr, Cu, Mo, Ni, Ru, Ta, Ti, V, W, and Zr. Exemplary transition metal salts include, but are not necessarily limited to: nitrates, chlorides, acetates, sulfates, carbonyls etc including, for example, iron nitrate, iron sulfate, iron acetate, iron chloride, cerium nitrate, chromium nitrate, copper nitrate, ammonium molybdate, nickel nitrate, ruthenium chloride, tantalum isopropoxide, titanium ethoxide, vanadium sulfate, ammonium tunstanate and zirconium nitrate. Furthermore, according to some embodiments the presently described methodologies may utilize precursors of two or more metals to produce multi-metallic catalysts.

Examples of suitably nitrogen-carbon precursors that have been found to be particularly suited for the bio-electrical systems as described in greater detail in the Examples section below include precursors of aminoantipyrine (AAPyr) and mebendazole (MBZ). Other suitable precursors include carbendiazim, nicarbazim, and Phenanthroline, phenylenediamine, PEI etc.

According to some embodiments, the M-N—C precursors and sacrificial support particles may be mixed together using solvents such as water, alcohols, or the like and using various known mechanical mixing or stirring means under suitable temperature, atmospheric, or other conditions as needed in order to enable or produce the desired degree of dispersion and degree of mixing of sacrificial particles within the mixture. Suitable mixing means include, for example, use of an ultrasound bath, which also enables dispersion of the sacrificial support particles.

Alternatively or additionally, the precursor(s) and sacrificial particles may be mixed together using mechanosynthesis techniques such as ball-milling. For the purposes of the present disclosure, the term “ball mill” is used to refer to any type of grinder or mill that uses a grinding media such as silica abrasive or edged parts such as buns to grind materials into fine powders and/or introduce to the system enough energy to start a solid state chemical reaction that leads to the formation of the desired final material.

It will be appreciated that the presently disclosed methods enable the production of catalytic materials having highly controllable morphology. Specifically, by selecting the ratio of sacrificial support particles to the M-N—C precursors and the size, shape, and even porosity of the sacrificial template particles, it is possible to control, select, and fine-tune the internal structure of the resulting material. In essence, the disclosed method enables the production of catalytic materials having as convoluted and tortuous a morphology as desired. For example, a highly porous open-structure “sponge-like” material may be formed by using larger sacrificial template particles, while a highly convoluted, complex internal structure may be formed by using smaller, more complexly shaped, sacrificial particles, including for example, sacrificial particles of different shapes and/or sacrificial particles which are themselves porous. Moreover, the “density” of the catalytic material can be selected by altering, for example, the ratio of sacrificial particles to M-N—C precursor materials, the shape of the template particles (i.e. how easily they fit together), or other factors.

Accordingly, it will be appreciated that the size and shape of the sacrificial particles may be selected according to the desired shape(s) and size(s) of the voids within the final product. Specifically, it will be understood that by selecting the particular size and shape of the support particles, one can produce a material having voids of a predictable size and shape. For example, if the template particles are spheres, the catalytic material will contain a plurality of spherical voids having the same general size as the spherical particles. For instance, assuming there is no alteration in the size of the particle caused by the synthesis method, in an embodiment where particles having an average diameter of 20 nm is used, the spherical voids in the final product will typically have an average diameter of approximately 20 nm. (Those of skill in the art will understand that if the diameter of the particle is 20 nm, the internal diameter of the void in which the particle resided will likely be just slightly larger than 20 nm and thus the term “approximately” is used to account for this slight adjustment.)

Accordingly it will be understood that the sacrificial particles may take the form of any two- or three-dimensional regular, irregular, or amorphous shape or shapes, including, but not limited to, spheres, cubes, cylinders, cones, etc. Furthermore, the particles may be monodisperse, or irregularly sized.

It will be further understood that because the material is formed using a sacrificial support technique, where the sacrificial material can be, for example, “melted” out of the supporting materials using acid etching or other techniques, the resulting material can be designed to have a variety of variously shaped internal voids which result in an extremely high internal surface area that can be easily accessed by, for example, gasses or liquids that are exposed to material (for example, in a fuel cell). Furthermore, because the size and shape of the voids is created by the size and shape of the sacrificial particles, materials having irregular and non-uniform voids can easily be obtained, simply by using differently shaped sacrificial particles and/or by the non-uniform distribution of sacrificial materials within the M-N—C precursor/sacrificial particle mixture. Furthermore, the sacrificial-support based methods of the present disclosure may produce catalytic materials having, for example, a bi-modal (or even multi-modal) pore distribution either due to the use of differently sized sacrificial particles or where a first smaller pore size is the result of removal of individual particles and thus determined by the size of the sacrificial particles themselves and a second, larger, pore size is the result of removal of agglomerated or aggregated particles. Accordingly, it will be understood that the method described herein inherently produces a material having a unique morphology that would be difficult, if not impossible, to replicate using any other technique.

As stated above, according to various embodiments, sacrificial particles of any size or diameter may be used. In some preferred embodiments, sacrificial particles having a characteristic length/diameter/or other dimension of between 1 nm and 100 nm may be used, in more preferred embodiments, sacrificial particles having characteristic length/diameter/or other dimension of between 100 nm and 1000 nm may be used and in other preferred embodiments, sacrificial particles having characteristic length/diameter/or other dimension of between 1 mm and 10 mm may be used. It should also be understood that the term “sacrificial particle” is used herein as a term of convenience and that no specific shape or size range is inherently implied by the term “particle” in this context. Thus while the sacrificial particles may be within the nanometers sized range, the use of larger or smaller particles is also contemplated by the present disclosure.

According to some embodiments, the sacrificial particles may themselves be porous. Such pores may be regularly or irregularly sized and/or shaped. The use of porous sacrificial particles enables the precursor(s) to intercalate the pores, producing even more complexity in the overall three-dimensional structure of the resulting catalyst.

Accordingly, it will be appreciated that the presently described methods enable the production of catalytic materials having a specifically tailored, highly complex, three dimensional structure. As provided in greater detail in the Examples section, it is believed that a tailored highly complex three-dimensional structure enables the creation of a highly corrugated and super-hydrophobic structure which allows optimization of the surface/water interface. This in turn, enables maximization of the transport of oxygen to the catalyst, overcoming one of the limitations of MFC performance—low maximum oxygen concentration in water.

It will be appreciated that the sacrificial particles may be synthesized and mixed (or coated, or infused, etc.) in a single synthesis step or the M-N—C precursor(s) may be mixed with pre-synthesized (whether commercially purchased or previously synthesized) sacrificial particles.

Of course it will be appreciated that given the various conditions that the sacrificial template will be subjected to during the synthesis process, it is important to select a sacrificial material which is non-reactive to the M-N—C precursors or catalytic materials under the specific synthesis conditions used and the removal of which will not damage the final material.

Silica is a material known to easily withstand the conditions described herein while remaining inert to a variety of catalytic materials including the metals described herein. Furthermore, silica can be removed using techniques that are harmless to the final materials. Thus, silica is considered to be a suitable material from which the sacrificial template particles can be made. According to some specific embodiments, 20 nm diameter spheres formed from mesoporous silica can be used. In this case the templating involves intercalating the mesopores of the silica template particles and the resulting material typically contains pores in the 2-20 nm range. In one particular embodiment, the silica template is commercially available Cabosil amorphous silica (400 m²/g⁻¹). Furthermore, selecting a different type of silica can also alter the shape and size of the pores in the final product. Those of skill in the art will be familiar with a variety of silica particles that are commercially available, and such particles may be used. Alternatively, known methods of forming silica particles may be employed in order to obtain particles of the desired shape and/or size.

However, while many of the examples herein utilize silica for the templating materials, it will be appreciated that other suitable materials may be used including, but are not limited to, zeolites, aluminas, and the like.

After the M-N—C precursor are mixed with the sacrificial support, to produce an M-N—C compound-sacrificial support mixture, the resulting material is heat treated. Heat treatment may be performed either in an inert atmosphere such as N₂, Ar, or He, or in a reactive atmosphere such as NH₃ or acetonitrile. Inert atmospheres are typically used when the M-N—C materials are nitrogen rich, as the inert atmosphere enables the production of a high number of active sites with Fe (or other metal) N₄ centers. However, it may be desired to use a nitrogen rich atmosphere if the M-N—C material is rich in carbon and depleted in nitrogen, as the nitrogen rich atmosphere will enable production of the Fe (or other metal) N₄ centers.

According to some embodiments, particularly embodiments wherein a single step synthesis method is used, optimal temperatures for heat treatment are typically between 500° C. and 1100° C. According to some embodiments, heat treatment may preferably be between 750° C. and 900° C., or more preferably between 775° C. and 825° C. In some embodiments, heat treatment of around 800° C. is preferred, as our experimental data showed this temperature to produce catalysts having a high amount of catalytic activity for certain specific materials (see experimental section below).

After heat treatment, the sacrificial template particles are removed resulting in a porous, M-N—C catalyst. In some cases the catalyst consists only of materials derived from the M-N—C precursors. Removal of the sacrificial template particles may be achieved using any suitable means. For example, the template particles may be removed via chemical etching. Examples of suitable etchants include NaOH, KOH, and HF. According to some embodiments, it may be preferable to use KOH, as it preserves all metal and metal oxide in the material and, use of KOH may, in fact, increase catalytic activity of the active centers. Alternatively, in some embodiments, HF may be preferred as it is very aggressive and can be used to remove some poisonous species from the surface of the support. Accordingly, those of skill in the art will be able to select the desired etchants based on the particular requirements of the supporting material being formed.

As stated above, the presently described catalytic materials can also be synthesized using a two-step procedure. In this procedure, the M-N—C precursors are mixed with the sacrificial support as described above, and the resulting M-N—C compound/sacrificial support mixture is then subjected to a first heat treatment step, such as pyrolysis, in order to produce an intermediate material that is rich with an unreacted metal, such as iron. The intermediate material is then subjected to a second heat treatment step, which may be, for example, a second pyrolysis treatment, resulting in newly formed active sites. After the second heat treatment, the sacrificial support is removed using chemical etching or other suitable means as described above.

In embodiments utilizing a two-step procedure, and therefore, two separate heat treatment steps, it may desirable for the different heat treatment steps to be conducted under different conditions, for example at different temperatures and/or for different durations of time. For example, the first heat treatment step may be performed at a higher temperature, such as 800° C. for 1 hour and the second heat treatment step may be performed at a temperature between 800 and 1000° C. for a period of time between 10 minutes and 1 hour.

Removal of the sacrificial support results in an unsupported or self-supported catalytic material. In this context, the terms “unsupported” and “self-supported” are both intended to mean that the entire physical structure is formed as a result of the above-mentioned sacrificial support-based method and that no additional structural materials are present to create or alter the morphology or structure of the material. As explained above, the method enables the production of a wide variety of morphologies—including both rigid and flexible morphologies and thus the resulting catalytic materials may be considered to be either self-supported (having sufficient rigidity to produce a desired morphology and thus not require additional supporting structure) or unsupported (and thus may, though not necessarily will, require additional supporting structure in order to achieve a desired morphology). Of course it will be understood that in some situations an unsupported catalytic material may be the desired end product. Furthermore, in some situations it may be desirable to decorate or otherwise attach a self-supporting catalytic material to another support material, for example in order to increase the catalytic activity of the catalytic material or simply to produce the desired final product in terms of shape, size, or other physical or chemical characteristics.

It will be understood that the catalytic material of the present disclosure provides a plurality of active sites which are typically chemical species that are able to participate in a catalytic reaction. It should be understood that the present disclosure contemplates that a particular catalytic material may contain active sites containing the same or different chemical species and that the chemical species are typically derived from the M-N—C precursors used to synthesize the catalytic material. However, it should be noted that the chemical species in any particular active may constitute only some or all of the M-N—C elements. Accordingly, the active sites may comprise or consist of metal, nitrogen and carbon, metal and nitrogen, metal and carbon, or only metal atomically dispersed or nanoparticles thereof.

Accordingly, it should be understood that the unsupported catalytic material may be further processed to prepare the catalyst to be deposited, painted, layered, attached, inserted, or otherwise associated with a supporting material, if desired. For example, the catalyst could be ground or ball-milled, if necessary, to obtain a powder having a desired particle size. Moreover, the catalyst could be mixed with a carbon black such as Vulcan XC-72 (Cabot, Corporation, Billerica, Mass.) and an ionomer such as Nafion (E.I. du Pont de Nemours and Company, Buffalo, N.Y.) to form an ink which can then be sprayed or otherwise deposited onto a surface. The catalyst, carbon black, and ionomer can be mixed together in any suitable ratio.

According to another embodiment, the supported, unsupported, or self-supported catalytic material can be used as a catalyst in a bioelectrical system, including, but not necessarily limited to the MCMFC and SCMFC systems described above. As described in greater detail in the Examples section below, MCMFCs and SCMFCs utilizing M-N—C ORR catalysts formed from iron aminoantipyrine (Fe-AAPyr) and iron mebendazole (Fe-MBZ) were substantially more cost effective than identical MFCs utilizing platinum-based catalysts even when lower performance was taken into account and, in fact, under certain conditions, the M-N—C catalysts outperformed the platinum-based catalysts. It should be understood that the specific morphology provided by catalysts produced using the sacrificial support method also enables tailoring of the surface to best accommodate the environmental conditions and desired activity of the catalyst. For example, according to some embodiments, the surface chemistry of the catalyst can be tailored and adapted to repel contaminants such as sulfur, or heavy metals by doping the surface with appropriate chemical functionalities, while also encouraging the adsorption of oxygen using surface functionalities such as hydroxide groups. Further, the techniques that can be used to make these modifications can be less extreme that those used for similar materials deployed in high or low pH environments because of the near neutral pH of bioelectric systems.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “a catalyst” may include a plurality of such catalysts, and so forth.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications identified above or below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications. Furthermore, inclusion or identification of a reference in the present disclosure does not, in and of itself, act as an admission that such publication is prior art to the inventions of present disclosure.

Additional information may be gathered from the Examples section below. Examples:

Study of Non-PGM catalysts for use in Double Chamber Microbial Fuel Cells

Synthesis of Fe-Aminoantipyrine (Fe-AAPyr). Fe-AAPyr catalyst was prepared by wet impregnation of iron and aminoantipyrine precursor onto the surface of fumed silica (Cab-O-Sil™ M5, surface area: ˜250 m² g⁻¹). First, a defined amount of silica (the total metal loading on silica was calculated as ˜25wt. %) was dispersed in acetone in an ultrasound bath. Then, a solution of 4-aminoantipyrine (Sigma-Aldrich) in acetone was added to the dispersed silica and ultrasonicated for 40 minutes. Finally, a water solution of iron (III) nitrate (Fe(NO₃)₃*9H₂O, Sigma-Aldrich) was added to the SiO₂-AAPyr solution and ultrasonicated for 8 hours. After ultrasonication, the gel-containing silica and Fe-AAPyr was dried overnight at 85° C. The solid material was ground to a fine powder, and heat treated (HT). The general conditions of the heat treatment were UHP nitrogen (flow rate 100 ml min⁻¹), 25 deg min⁻¹ temperature ramp rate until 950° C. followed by 30 minutes of pyrolysis. The silica support was removed by 20 wt % of hydrofluoric acid. The resulting catalyst was washed with DI water until pH=7 and dried overnight at 85° C. In order to obtain 1 gram of Fe-AAPyr catalyst, 0.3-0.4 g of Fe(NO₃)₃*9H₂O, 3-4 g of AAPyr, 1-2 g of silica and 7-10 ml of HF were used. The estimated cost of the raw materials for each gram was roughly $3.20-3.40 US dollars.

Synthesis of Fe-Mebendazole (Fe-MBZ). Fe-MBZ catalysts were prepared by mechanochemical dispersion of iron and mebendazole precursor onto the surface of fumed silica (Cab-O-Sil™ M5, surface area: ˜250 m² g⁻¹). Silica, iron (III) nitrate and mebendazole were roughly mixed together in a glass beaker and transferred into a 100 ml agate ball-mill jar. A defined amount of agate balls (diameter 10 mm) were added to the mixture. The material was ball-milled for 1 hour at 500 RPM. The fine powder was then heat treated at an inert atmosphere. The general conditions of the heat treatment were UHP nitrogen (flow rate 100 ml min⁻¹), 15 deg min⁻¹ temperature ramp rate until 900° C. and 1 hour of heat treatment. The silica support was removed by 20wt. % of hydrofluoric acid. The resulting catalyst was washed with DI water until pH=7 and dried overnight at 85° C. In order to obtain 1 gram of Fe-MBZ catalysts, 0.3-0.4 g of Fe(NO₃)₃*9H₂O, 3-4 g of MBZ, 1-2 g of silica and 7-10 ml of HF were used. The estimated cost for each gram was roughly $3.40-3.60 US dollars.

Ink preparation and spray. Inks were prepared by mixing 120 mg of the above catalysts with 45 weight percent (wt. %) Nafion® and enough IPA to bring the total volume of ink to 7 mL. The ink was then sonicated in a sonic bath for an hour. A 10 cm² piece of Toray paper was taped to a hot plate (T=60° C.) and the ink was sprayed directly on it using an air brush. Prior to spraying the weight of the Toray paper was measured. The initial weight was subtracted from the final weight of the Toray paper after spraying. The difference was then divided by the total area to get the total loading. The total loading was multiplied by the wt. % of the catalyst in ink, in this case 55%, to determine the total catalyst loading. The catalyst loading on the cathode surface was found to be 5±0.5 mg cm⁻² (Fe-AAPyr), 5±0.5 mg cm⁻² (Fe-MBZ) and 0.5±0.5 mg cm⁻² (Pt). The cathode was connected to a nickel-chrome wire and the contact was glued using an epoxy resin. The nickel chrome wire was then inserted into a PTFE tube in order to avoid direct exposure of the wire to the electrolyte.

Materials Surface Analysis. The morphology of the synthesized catalysts was determined using Scanning Electron Microscopy (SEM) and Transmission Electron Microscopy (TEM). SEM and TEM provided information on the morphology of the bulk and individual particles of the catalyst. TEM images were acquired using a JEOL 2010 microscope with an accelerating voltage of 200 kV and a current of 190 μA. XPS measurements were performed with a Kratos Axis Ultra DLD X-ray photoelectron spectrometer using a monochromatic Al K_{α}source operating at 300 W. Survey and high-resolution C 1s, O 1s, N 1s and Fe 2p spectra were acquired at pass energies of 80 and 20 eV, respectively. Three areas per sample were analyzed. No charge compensation was necessary. Data analysis and quantification were performed using the CASAXPS software. A linear background was used for C 1s, N 1s, and O 1s, while Sherley background was used for Fe 2p spectra. Quantification utilized sensitivity factors that were provided by the manufacturer. A 70% Gaussian/30% Lorentzian (GL(30)) line shape was used for the curve-fits.

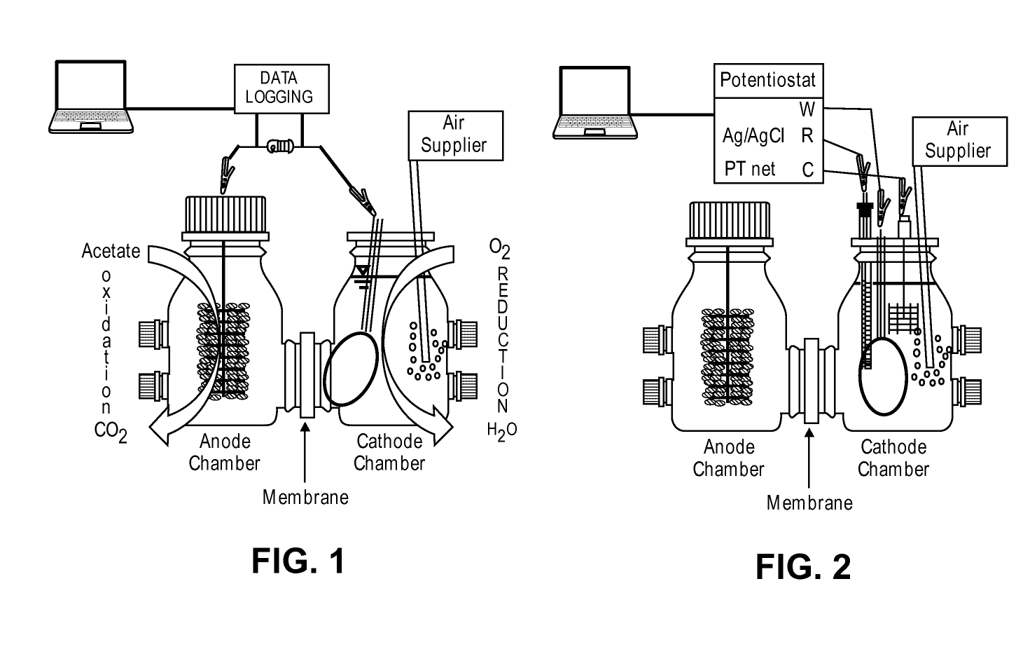

Double Chamber MFC Configuration. A double chamber glassy MFC with a proton exchange membrane (Nafion® 211) and 130 ml compartments was used to study the performance of cathodes incorporating the above-described non-PGM catalysts. As shown in FIG. 1 the cathodes were placed in the double chamber MFC asMFC as close as possible to the membrane. The anode was composed of carbon brushes (6×4 cm projected surface area) pre-colonized with mixed cultured bacteria as described in C. Santoro, S. Babanova, P. Atanassov, B. Li, I. Ieropoulos, P. Cristiani. J. Electrochem. Soc. 2013, 160 (10), H720-H726. The anode chamber was filled with 50 v/v % phosphate buffer saline solution (PBS, 50 mM) and 50 v/v % of activated sludge (pH=7.5±0.1). The non-PGM cathode (2×2 cm geometric area) was incorporated in the MFC and exposed to buffer solutions with different pHs (6, 7.5, 9 and 11) and continuously purged with air for oxygen supply. The performance of the MFC was investigated at different cathode compartment pH values in order to investigate the influence of pH on the cathode as well performance of the MFC overall.

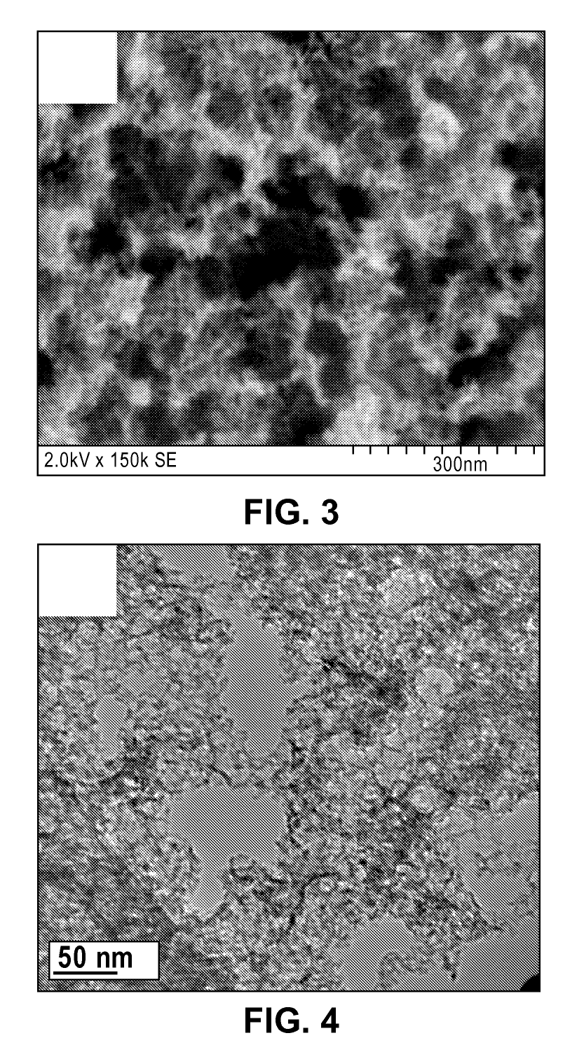

Electrochemical measurements and analysis. Electrochemical measurements were carried out in order to characterize the performance of the Fe-AAPyr and Fe-MBZ cathodes compared to platinum-based cathodes at the different pH values. As shown in FIG. 2, the cathodes were immersed into the cathodic solution and connected to the anode over an external resistance of 1000 Ω. The same anode and anodic solution were used for the tests. Before taking any electrochemical measurement, the DMFC were run for at least 2 days. Cathodes Open Circuit Potentials (OCPs) were measured using a multimeter versus Ag/AgCl (3M KCl) reference electrode. The open circuit voltages (OCV) of the complete MFCs were measured using a multimeter with no external resistance or loading applied. The DCMFC was disconnected for at least one hour and the OCVs that were recorded had to be steady-state (±3 mV) before being considered correct. Single electrode potentiodynamic polarization curves were carried out separately for the anode and cathode using a stainless steel 304 mesh as a counter (with specific area much larger than the electrodes studied) and Ag/AgCl (3M KCl) as reference electrodes with a scan rate 0.2 mVs⁻¹ (Fi). The overall polarization curves of the MFCs were measured using a potentiostat (Gamry P600) with a scan rate of 0.25 mVs^{-1 [41]}. Power curves were obtained using Ohm's law (P=V×I, where P=power, V=voltage and I=current, respectively) and consequently represented as power density considering the geometric area of the cathode (4 cm²). Morphology and Surface Chemistry Analysis. The morphology of the Fe—N—C catalyst was evaluated by SEM and TEM (SEM and TEM images of Fe-AApyr are shown in FIGS. 3 and 4, respectively). It can be seen that material displays well-developed 3D structure, which was formed after removal of the sacrificial support (silica particles). The open-framed structure affected both the density of active sites and their accessibility to oxygen, both of which were significantly increased.

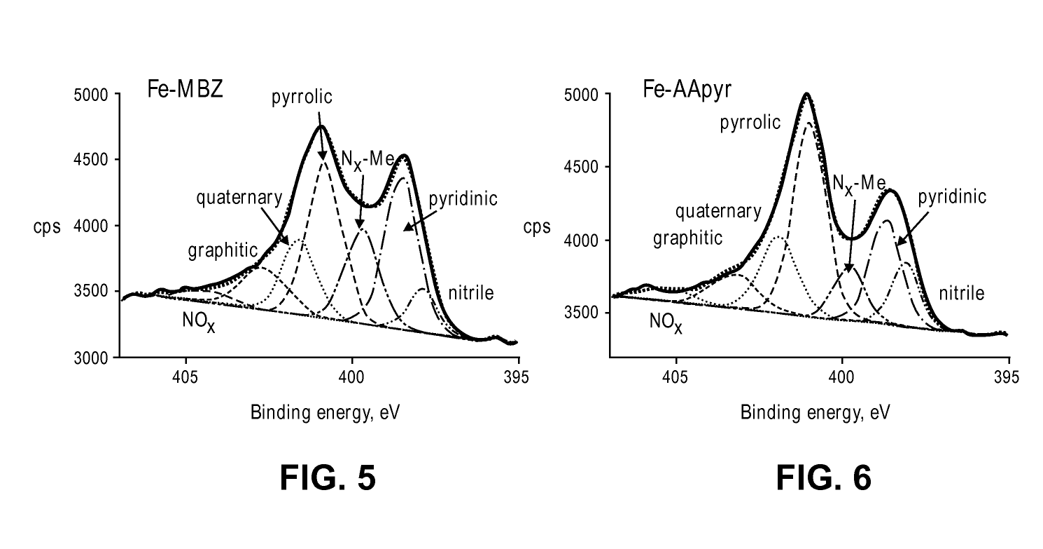

Based on the XPS analyses of the two types of catalysts, it was established that the Fe-AAPyr and Fe-MBZ catalysts displayed similar surface composition. 5.2 at. % and 3.6 at. % of N was observed in Fe-MBZ and Fe-AAPyr samples, respectively, while both samples had equivalent amounts of Fe— 0.16 at %. FIGS. 5 (Fe-MBZ) and 6 (Fe-AApyr) show high resolution N 1s spectra for both samples, which were decomposed into 7 peaks in correspondence with the types of N species established for M-N—C family of electrocatalysts. These are nitrile (398.0 eV), pyridinic (398.6 eV), pyrrolic (400.7 eV), quaternary (401.8 eV) and graphitic (403 eV) nitrogens, NOx (404.5 eV) and N coordinated to Fe at 399.2-399.5 eV. In comparison with Fe-AApyr sample, Fe-MBZ had a smaller relative amount of pyrrolic and a larger relative amount of both pyridinic and nitrogen coordinated to Fe. The amounts of the latter types of N species have been shown to be directly related to ORR activity. (See e.g., A. Serov, K. Artyushkova, P. Atanassov. Fe—N—C Oxygen Reduction Fuel Cell Catalyst Derived from Carbendazim: Synthesis, Structure, and Reactivity. Advanced Energy Materials, n/a-n/a (2014)10.1002/aenm.201301735; U. I. Kramm, J. Herranz, N. Larouche, T. M. Arruda, M. Lefevre, F. Jaouen, P. Bogdanoff, S. Fiechter, I. Abs-Wurmbach, S. Mukerjee, J. P. Dodelet. Phys Chem Chem Phys 2012, 14, 11673-11688; U. Tylus, Q. Jia, K. Strickland, N. Ramaswamy, A. Serov, P. Atanassov, S. Mukerjee. Elucidating Oxygen Reduction Active Sites in Pyrolyzed Metal-Nitrogen Coordinated Non-Precious-Metal Electrocatalyst Systems. The Journal of Physical Chemistry C, (2014)10.1021/jp500781v.)

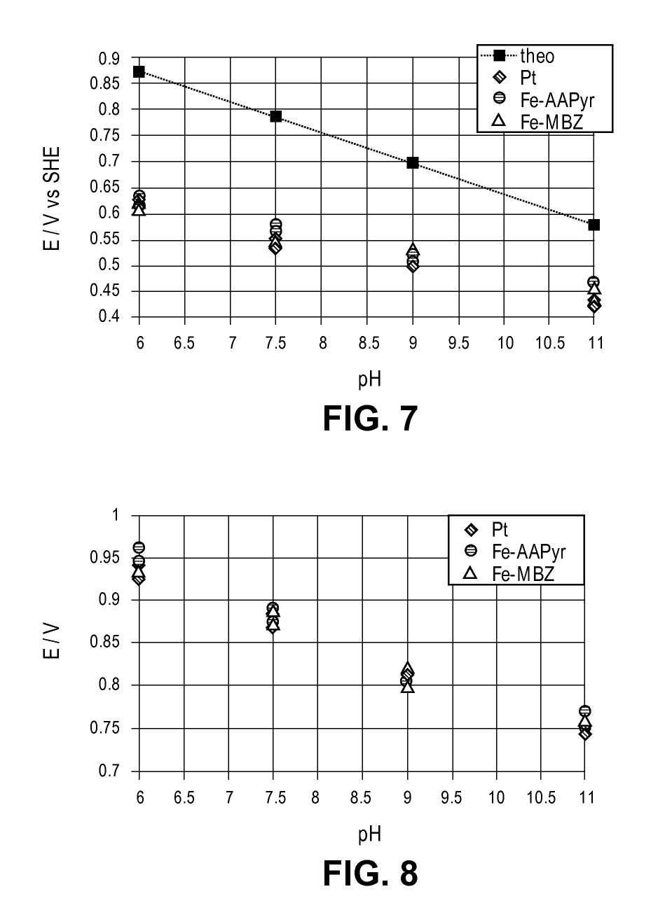

Cathodes OCPs and Overall MFCs' open circuit voltages. FIG. 7 shows the OCPs for the cathodes measured at different cathodic solution pH values and compared to the theoretical value for ORR, where the theoretical potential of the oxygen reduction reaction varies from ≈0.87 V (vs. SHE) at pH 6 to ≈0.57 V (vs. SHE) at pH 11 with a decrease of 0.059 V per pH unit.

Only a slight difference was found among the OCPs of the investigated cathodes at the different pHs, indicating similar thermodynamic aspects. The OCP of the cathodes varied between 0.61 and 0.633 V at pH 6, between 0.54 and 0.576 V at pH 7.5, 0.498 and 0.52 V at pH 9 and between 0.435 and 0.458 V at pH 11. The relative standard deviation was roughly 5-10% for each pH and can be considered as negligible. It should be noticed that the overpotential (difference between theoretical and measured value) decreased with the increasing pH values of the cathodic solution for both Pt and M-N—C catalysts. In fact, the overpotential reduced from ≈0.23 V at pH 6 to ≈0.13 V at pH 11 indicating an increasing catalytic activity of these materials from pH 6 to pH 11 that is slightly more pronounced for the Fe—N—C materials than for Pt. In S. Brocato, A. Serov, P. Atanassov. Electrochim Acta. 2013, 87, 361-365., The catalytic activity of Fe-AAPyr catalyst at the pH range from 1 to 13.5 was investigated using rotating disc ring electrode measurements. It was established that the rate-limiting step in alkaline media (pH 7 to 13.5) is dependent on the OH⁻ concentration with a slope of approximately +30 mV/pH, indicating that the first electron charge transfer step is rate limiting. It was also proposed that the intermediate H202 was activated at the Fe-containing active centers, which could explain the lower overpotential at higher pHs.

Due to the similarity of the OCP of the anodes (−480 mV/−512 mV vs Ag/AgCl) for each DCMFC used, the overall OCV followed the cathodes OCP trend (See FIG. 8). The highest OCV was measured at the lowest pH (equal to 6), with values between 0.927 and 0.948 V and the lowest OCV was measured at the highest pH (equal to 11) with values ranging between 0.742 and 0.768 V, following the theoretical dependence of ORR potential as a function of pH.

Performance of Single cathodes. Characterization of the single cathodes was performed to study the differences between the electrodes at the different pH conditions.

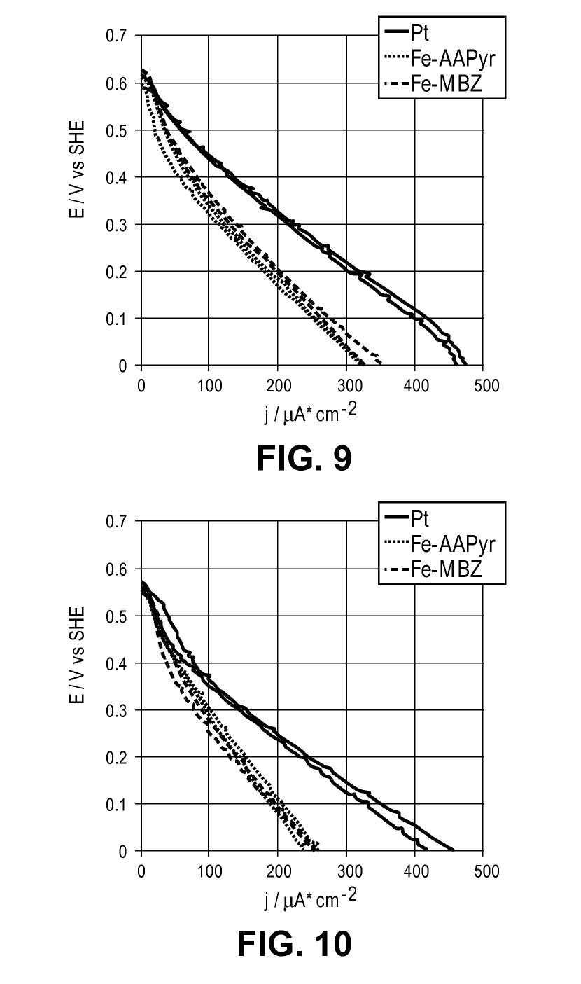

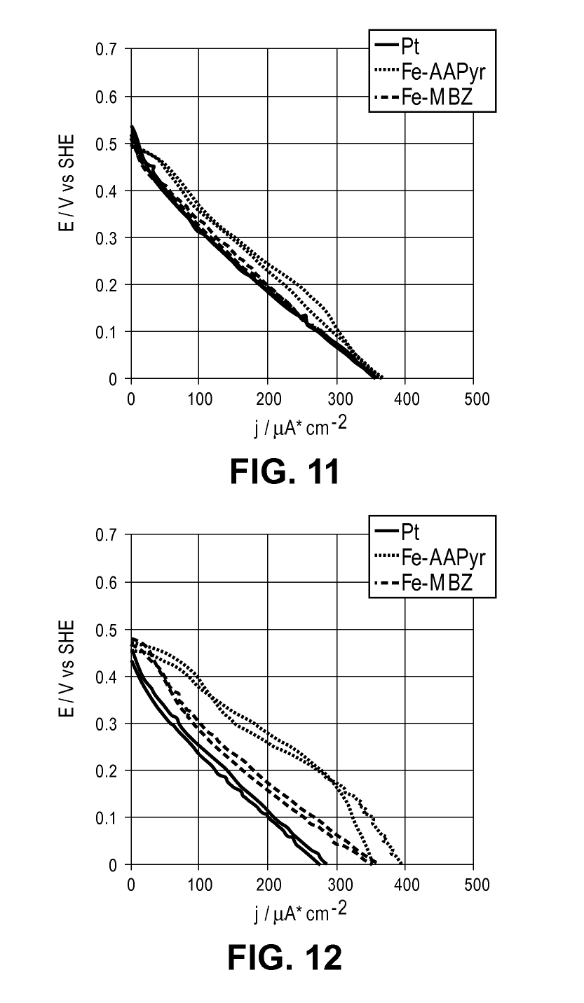

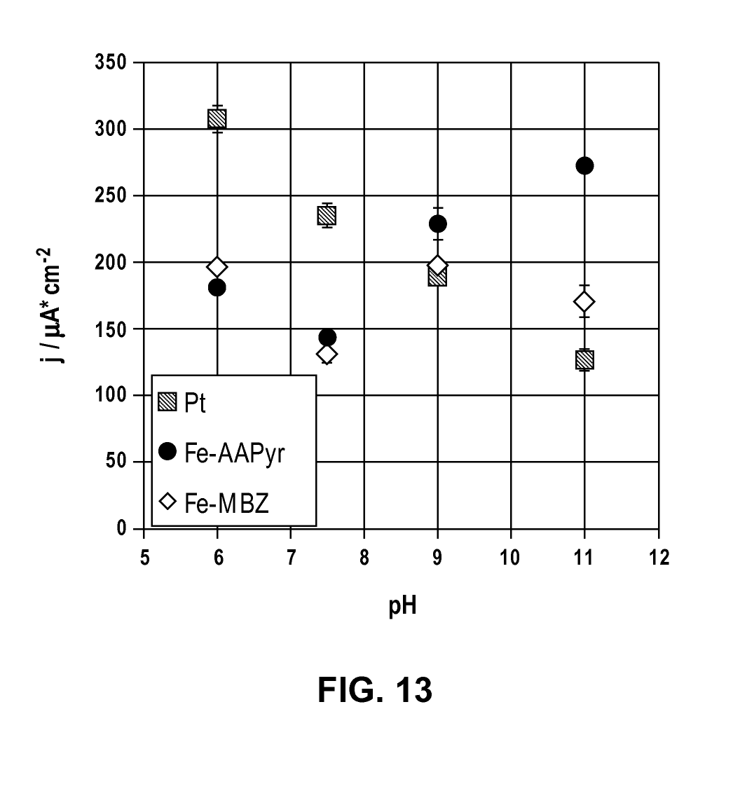

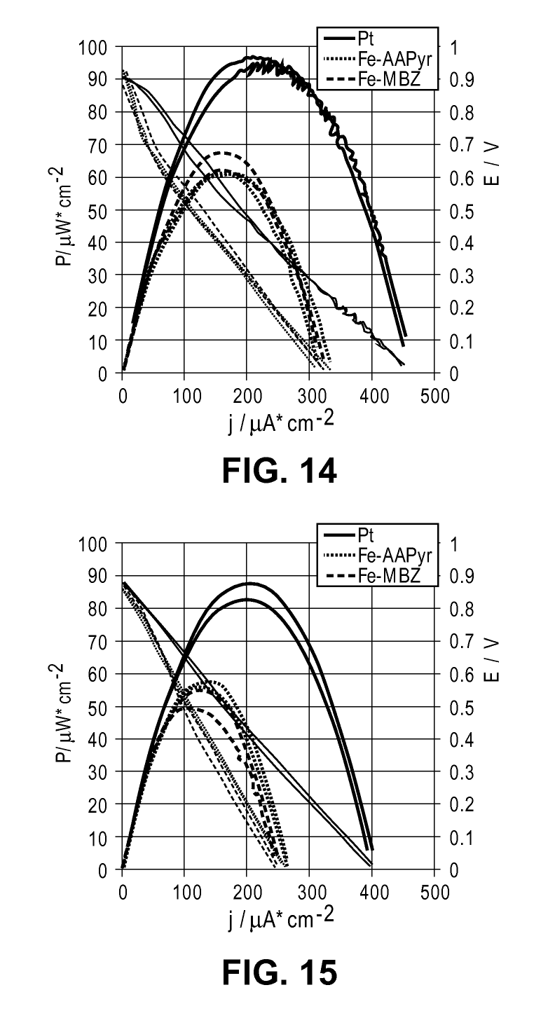

Variation in the performance of the cathodes was obtained as a function of pH as shown in FIGS. 9-12. A parabolic dependence of the current densities of the M-N—C cathodes from the electrolyte pH was observed with a minimum at pH 7.5 and slight increase from pH 7.5 till pH 11. In contrast, the performance of the Pt-based cathode constantly decreased with increasing in pH in agreement with B. Erable, L. Etcheverry, A. Bergel, Alain. Electrochem. Comm 2009, 11, 619-622. In fact, Erable et al. suggested the utilization of a platinum based cathode in MFCs at very low pH values, where the Pt activity is higher, to justify the utilization of the noble material for the oxygen reduction reaction. As a result at the lower pHs investigated (pH 6 and 7.5), the Pt-based cathode demonstrated higher electrochemical activity compared to the non-PGM catalysts (FIGS. 11 and 12). Then at pH 9, the Fe-AAPyr cathode had slightly higher performance compared to the Pt-cathode and similar electrocatalytic activity compared to Fe-MBZ (FIG. 13). When the pH of the catholyte was set to pH 11, the Fe-AAPyr and Fe-MBZ cathodes outperformed the Pt-cathode (FIG. 14).

The current densities generated by the non-PGM cathodes as a function of catholyte pH (FIG. 13) follow our previous studies, where it has been shown that kinetic current due to ORR on these materials linearly decreases with increasing pH from 1 to 7, where a minimum is reached. See e.g., S. Brocato, A. Serov, P. Atanassov. Electrochim Acta. 2013, 87, 361-365. At higher pHs (7-14), both kinetic current and half wave potential increase due to changes in the ORR mechanism from inner-shere electron transfer and 4e⁻ mechanism in acidic media to combined inner- and outer-sphere electron transfer mechanisms (2e⁻ process) in alkaline media. A similar change in the ORR mechanism is proposed for Pt with the main difference that the oxygen reduction kinetic on Pt in alkaline media is sufficiently lower than in an acidic environment and a decrease in catalyst activity is observed with increasing OH⁻ concentration. See e.g., N. Ramaswamy and S. Mukerjee. Advances in Physical Chemistry, 2012, 2012, doi:10.1155/2012/491604. Unfortunately there is no detailed information about the mechanism of ORR on Pt surfaces in neutral media.

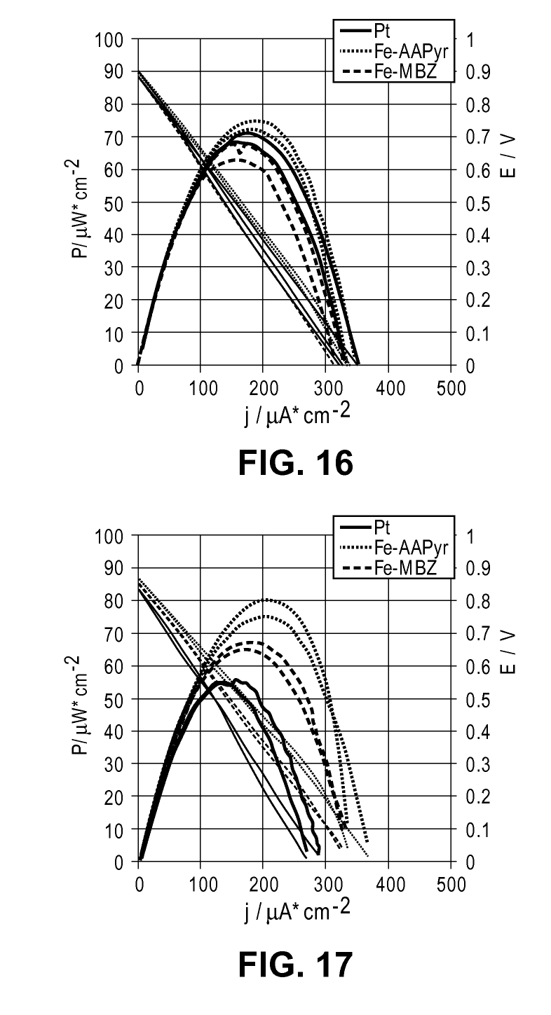

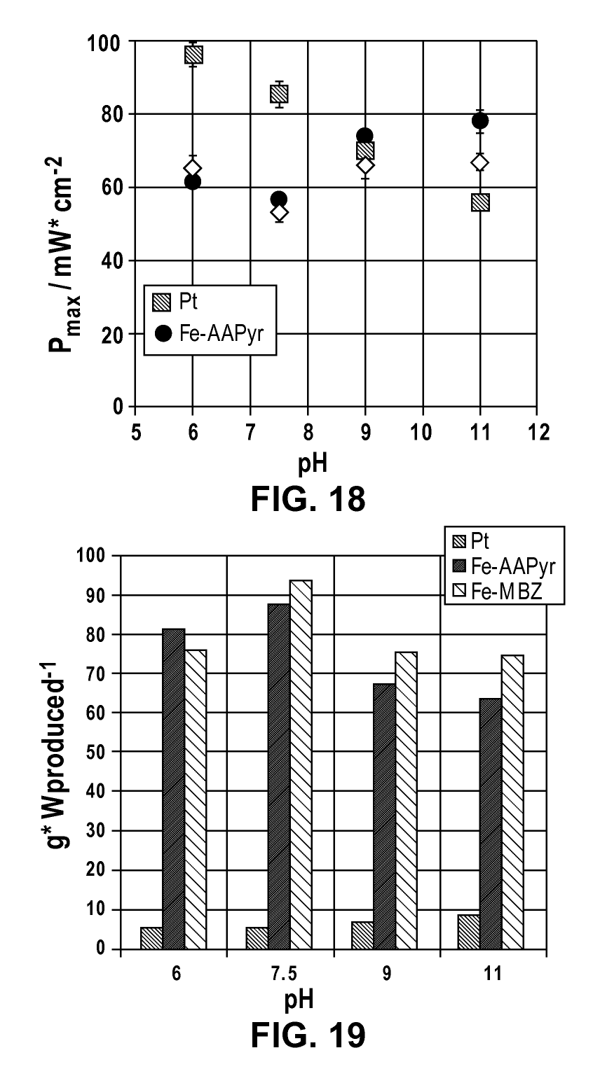

Complete DCMFC performance The maximum power for the DMFC with the Pt-based cathode was 93-95 μW cm⁻² at pH 6 (FIG. 14), 82-87 μW cm⁻² at pH 7.5 (FIG. 15), 70-72 μW cm⁻² at pH 9 (FIG. 16 and 54-56 μW cm ⁻² at pH 11 (FIG. 17). The linear decrease of the maximum power with increasing pH is consistent with the single Pt-cathode performance at various pHs (FIG. 19). The DCMFCs with Fe-AAPyr and Fe-MBZ-based cathodes demonstrated the lowest maximum power density at pH 7.5 after which the power started to increase (FIG. 18). The power density of the DCMFC with Fe-AAPyr was 59-61 μW cm⁻² at pH 6 (FIG. 14), 56-59 μW cm ⁻² at pH 7.5 (FIG. 15), 71-74 μW cm⁻² at pH 9 (FIG. 16) and 75-81 μW cm⁻² at pH 11 (FIG. 17). The Fe-MBZ based cathode DMFC behaved similarly to the Fe-AAPyr based cathode DMFC with slightly lower performance. The DMFC with the Pt-based cathode had the highest power density when the catholite had a pH of 6 and 7.5 while the highest power density at pH 9 and 11 was achieved by the Fe-AAPyr MFC. The MFC with the Pt-based cathode had 35% higher maximum power at pH 6 and 30% higher at pH 7.5 compared to the MFC with the Fe-AAPyr cathode. In contrast, the MFC with the Pt-based cathode had 4% lower performance at pH 9 and much lower at pH 11 (−40%). These results revealed that Pt is a better catalyst at lower pHs but non-PGM catalysts outperform Pt catalysts in alkaline media and are the better choice for the construction of cathodes that are intended to operate at high pH levels.

Cost-Performance analysis and Future Prospective. The high cost of the precious catalysts utilized at the cathode is one of the major problems that hinder the large-scale applications of microbial fuel cells. Consequently, a cost-performance analysis is presented here in order to justify the advantages of the utilization of non-platinum catalysts. For simplicity, the parameter considered for both platinum and non-PGM catalysts is the cost of the raw materials used to produce the respective cathodes since this is the major component determining the overall cost of ORR cathodes.

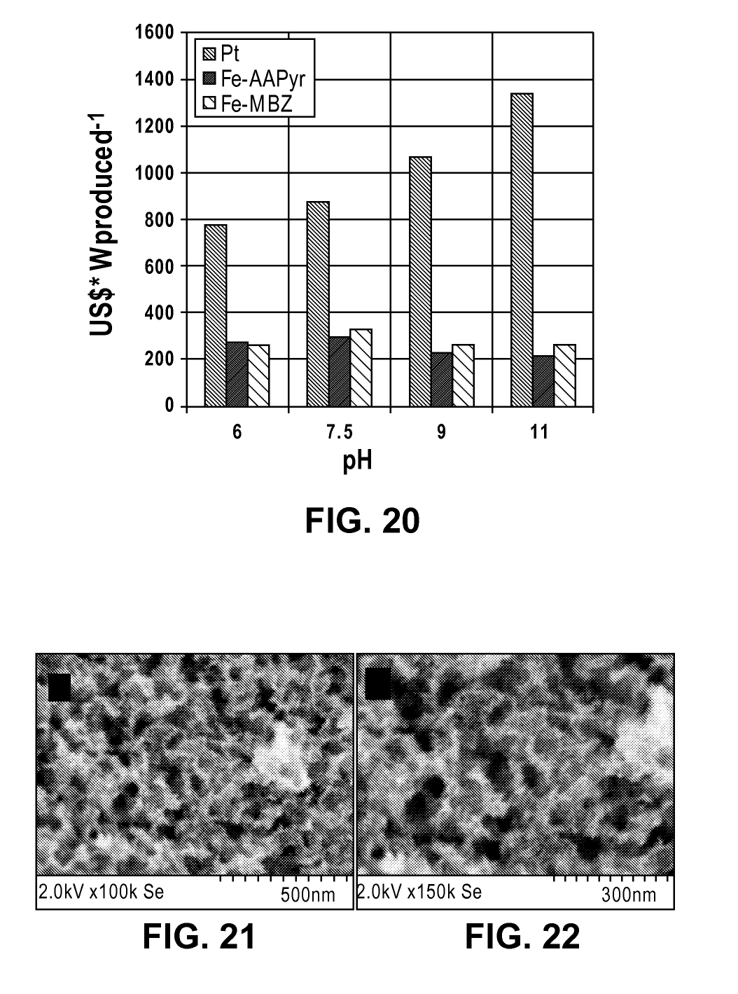

Based on the materials preparation procedure described above, the cost of preparing the non-PGM catalysts is estimated to be between $3.20 and $3.40 per gram for Fe-AAPyr and between $3.40 and $3.60 per gram for Fe-MBZ. The cost of platinum is approximately $150 per gram (Alfa Aesar, Johnson Matthew Company). The cost effectiveness of the designed cathodes was calculated as the cost the materials per 1 W of electricity produced. The catalyst loading (g) used for the production of 1 W of electricity showed a significant difference between Pt and non-PGM catalysts, as the non-PGM catalysts had a loading that was an order of magnitude higher than Pt (FIG. 19). However, the dramatic difference in raw material cost (50 times) resulted in a dramatic decrease in cost per power for the non-PGM catalysts, even at pH values where Pt outperformed the non-PGM catalysts. As shown in FIG. 20, the cost was reduced 3 times at pH 6 and 7.5 when platinum had higher power generation compared to non-PGM, reduced 5 times at pH 9 and between 6 and 7 times at pH 11.

The analysis led to an estimation of costs that varied between $780 and $1340 per watt for an MFC using a Pt-based cathode, between $215 and $296 per watt for MFCs utilizing an Fe-AAPyr cathode, and between $262 and $329 per watt for MFCs utilizing an Fe-MBZ cathode. Moreover, the cost effectiveness of non-PGM cathodes can be further enhanced by optimizing the electrode design and decreasing the catalyst loading.

### II . . . Study of Non-PGM Catalysts for use in Single Chamber Microbial Fuel Cells

Cathode materials. Three different cathode catalysts were investigated and compared: i) a platinum-based catalyst, ii) a non-PGM-based catalyst with aminoantipyrine as a precursor (Fe-AAPyr), and iii) an AC based catalyst. All three materials had the same support composed of a gas diffusional layer (GDL) built on a carbon cloth as an electron acceptor and a mixture of AC/PTFE pressed on the top of it. In the case of materials i) and ii), an additional catalytic layer was applied while in case of iii), the AC was the catalyst.

The non-PGM catalyst included iron and aminoantipyrine as precursors (Fe-AAPyr). Initially, a dispersion of silica (Cab-O-Sil™ LM150, ˜200 m² g⁻¹, giving a metal loading on silica of 25 wt %) in acetone was obtained by using a low-energy ultrasonic bath. A solution of 4-aminoantipyrine (Sigma-Aldrich) in acetone was separately dispersed in acetone and then added to the silica colloidal solution and ultrasonicated for an additional 40 minutes. Iron (III) nitrate (Fe(NO₃)₃*9H₂O, Sigma-Aldrich) was first diluted in distilled water and then added in the SiO₂-AAPyr solution and ultrasonicated for roughly 8 hours. The gel formed at the end, containing SiO₂-Fe-AAPyr, was dried for 12 hours at a controlled temperature (85° C.) and then ground to a fine powder using a mortar and pestle. The sample was heated with a temperature ramp rate of 25° C. per minute from room temperature to 950° C., followed by pyrolysis for 30 minutes. The heat treatment was done in Ultra High Purity (UHP) nitrogen with a flow rate of 100 ml min⁻¹. Finally, the silica sacrificial support was removed using hydrofluoric acid (20 wt. %) and the catalyst was washed in distilled water and dried for 12 hours at 85° C.

GDL preparation. The cathode support was prepared using a gas diffusion electrode design as described in Santoro, C., Artyushkova, A., Babanova, B., Atanassov, P., Ieropoulos, I., Grattieri, M., Cristiani, P., Trasatti, S., Li, B. & Schuler, A. J. Parameters characterization and optmization of activated carbon (AC) cathodes for microbial fuel cell applications. Bioresour. Technol. 163, 54-63 (2014). Commercial PTFE-treated carbon cloth (30 % wt PTFE, Fuel Cell Earth) was used as an electron collector. On top of it, a mixture of commercial AC (BET area of 802 m²g⁻¹, Calgon, Pittsburgh, Pa.) and PTFE dispersion (60% dispersion in water, Sigma Aldrich) was mixed using a blender. The AC/PTFE ratio was 80/20 wt. %. The AC/PTFE mixture was weighed, placed on the carbon cloth (loading of 60±2 mg cm⁻²) and then pressed at 1400 psi for 5 minutes. After being pressed, the electrode was heated at 200° C. for 1 hour.

Catalytic layer preparation. Inks of Fe-AAPyr and Pt were prepared by mixing the catalyst (120 mg) with Nafion® (45wt %) and isopropanol (IPA). The IPA was added in order to reach a solution volume of roughly 7 mL. The inks were then ultrasonicated for 1 hour. The cathode support used a carbon cloth was pressed with the AC/PTFE mixture, which was then taped on a hot plate with a controlled temperature of 60° C. the above-described ink was then applied on the surface using an air brush spray gun. The temperature of 60° C. allowed for fast evaporation of IPA. Catalyst loading was determined by the change in the weight of the electrodes from the initial weight to the weight after ink spray. The loading was calculated by dividing the weight change by the sprayed surface area. The catalyst loadings onto the cathode surfaces were 2.1±0.3 mg cm ⁻² (Fe-AAPyr) and 0.2±0.15 mg cm⁻² (Pt).

Materials Surface Analysis. Scanning Electron Microscopy (SEM) and Transmission Electron Microscopy (TEM) were used to determine the morphology of the synthesized catalysts. SEM and TEM images gave important information on the bulk morphology and the individual particle distribution of the analyzed catalyst. SEM images were acquired using an S-3700, Hitachi, Japan. Additionally, TEM images were acquired using a JEOL 2010 microscope with an accelerating voltage of 200 kV and a current of 190 μA.

Surface chemistry of the catalyst before and after the poisoning tests were carried out using X-ray photoelectron spectrometer (XPS) with a Kratos Axis Ultra DLD XPS using a monochromatic Al Kα source operating at 300 W. Survey and high-resolution F 1s, C 1s, O 1s, N is and Fe 2p spectra were acquired at pass energies of 80 and 20 eV, respectively. Three areas per sample were analyzed. No charge compensation was necessary. Data analysis and quantification were performed using the CASAXPS software. A linear background was used for F 1s, C 1s, N 1s, and O 1s, while Sherley background was used for Fe 2p spectra. Quantification utilized sensitivity factors that were provided by the manufacturer. A 70% Gaussian/30% Lorentzian (GL(30)) line shape was used for the curve-fits.

SCMFC Configuration and operating conditions. A membraneless glassy SCMFC with a volume of 130 ml was used, where the anode and the cathode were exposed to the same electrolyte. See e.g., C. Santoro, C., Guilizzoni, M., Correa Baena, J. P., Pasaogullari, U., Casalegno, A., Li, B., Babanova, S., Artyushkova, K. & Atanassov, P. The effect of carbon surface properties on bacteria attachment and start up time of microbial fuel cells. Carbon 67, 128-139 (2014). The cathodes (geometric area of 2.9 cm²) were screwed on a lateral hole using a clamp. With the gas-diffusion cathode described above the carbon cloth faced the air, while the catalyst faced the solution. The anode, composed of a carbon brush (6×4 cm² projected surface area), was completely immersed in the solution. The anodes were pre-colonized by mixed cultures bacteria as described above with respect to the DCMFC analysis. The operating solution was a mixture of phosphate buffer saline solution (PBS, 50 mM and 25 mM KCl) and activated sludge (pH=7.5±0.1) from Albuquerque Southeast Water Reclamation Facility (New Mexico, USA) with a 1:1 volume ratio. Sodium acetate in a concentration of 1 gL⁻¹ was used as a fuel source for the bacteria at the beginning of each test cycle. The operating temperature was 21±1° C. The experiments were carried out in Albuquerque, New Mexico which is located at approximately 1600 meters above sea level. At this altitude, the atmospheric pressure is roughly 20% lower than at sea level and consequently the oxygen concentration is lower than at sea level. Lower oxygen concentration can negatively affect the performance of the cathode.

Electrochemical measurements and analysis. The SCMFCs were operated with a constant load and the anode and the cathode were connected to an external resistance of 470 Ω. The voltage was recorded every 25 minutes. Single electrode potentiodynamic polarizations curves of the anode and the cathode separately were measured in a three-electrode configuration with a Pt mesh as a counter electrode (specific area comparable to the electrodes investigated), Ag/AgCl (3M KCl) as a reference electrode, and the cathode or the anode as a working electrode, respectively. (See e.g., Li, B., Zhou, J., Zhou, X., Wang, X., Li, B., Santoro, C., Grattieri, M., Babanova, S., Artyushkova, K., Atanassov, P. & Schuler, A. J. Surface Modification of Microbial Fuel Cells Anodes: Approaches to Practical Design. Electrochim. Acta 134, 116-126 (2014).) The polarization curves were performed from OCP to −0.1 V for the cathode and for the anode (from OCP to −0.2 V) with a scan rate of 0.2 mVs⁻¹³⁹. Before the polarization curves, the SCMFC was disconnected until a steady-state OCP was reached (±3 mV).

The overall polarization curves of the MFCs were recorded using a potentiostat (Gamry P600) with a scan rate of 0.2 mVs⁻¹. In this case, counter and reference channels were short-circuited, and both were connected to the cathode, while the working electrode was connected to the anode. The current-voltage curves were then used to obtain the current-power curves using the Ohm law (P=I*V). The current and power were represented in the form of density referred to the cathode geometrical area (2.9 cm²).

Poisoning tests. Chronoamperometry analyses of the three cathodes were performed at constant voltage of 0 V (vs. Ag/AgCl) using the three-electrode configuration previously described. During the electrode polarization, aliquots of the pollutants (S²⁻ and SO₄²⁻) was introduced in the electrolyte measuring the current response. The addition of pollutants varied in the range 0.1 mM and 20 mM. The poisoning effect was calculated as the difference between initial current and current generated after the addition of the pollutant to a given concentration, with the current measured between 15-20 minutes after each addition of each pollutant dose. The current losses were also calculated as function of the pollutants dose.

Results and Discussion. Three gas-diffusion cathodes composed of a catalytic layer sprayed onto a teflonized carbon black, gas-diffusion layer (GDL) were evaluated in both “clean” conditions (PBS) and with real wastewater. The performances of Pt, activated carbon (AC) and Fe-AAPyr as cathode catalysts were compared.

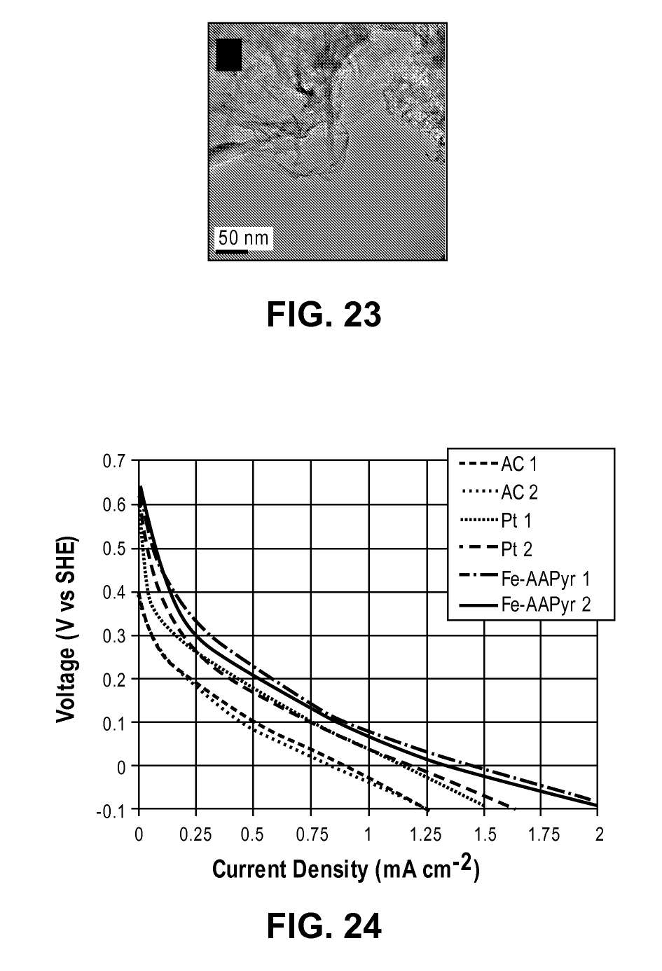

Surface Morphology. Morphological analysis of the Fe-AAPyr catalyst by SEM revealed that the material possesses a highly developed three-dimensional open-frame structure as shown in FIG. 21-23. Two types of pores can be seen at higher magnification (FIG. 23): pores with diameter ˜60-90 nm were created after removal of the sacrificial support, while smaller pores ˜10-15 nm were formed during the decomposition of the aminoantipyrine. A TEM image of Fe-AAPyr is shown in FIG. 24. The catalyst has heterogeneous morphology with clear indication of a highly graphitic, high surface area, and a three-dimensional, graphene-like structure. This 3D open-frame structure provides better contact between the reacting species and the catalyst active centers and thus enhances current performance.

Single Electrode Performance in “Clean” Conditions. Linear sweep voltammetry (LSV) was performed in PBS solution with a pH 7.4 (“clean” conditions) in order to compare the electrocatalytic activity of the catalysts without the influence of any additional factors. Pt was included as a benchmark, since it is considered to be the most active catalyst for ORR. Before the test, the cathodes were exposed to the PBS solution for at least 12 hours, until the open circuit potential (OCP) was stabilized, to achieve complete wettability of the catalyst. Initial cathode OCPs for Pt and Fe-AAPyr were similar, 630±18 mV (vs. SHE) and 637±8 mV (vs. SHE) respectively. Much lower values were measured for the AC-based cathode (402±10 mV vs. SHE).

The Fe-AAPyr cathode demonstrated slightly higher cathodic activity than Pt, and much higher activity than AC, based on LSVs carried out in PBS (FIG. 24). This result differed from that found in the double-chamber MFC discussed above, where Pt outperformed the Fe-AAPyr. This discrepancy might be due to the utilization of the Pt and the Fe-AAPyr in this study in a gas diffusion electrode design in contrast to the submerged in the electrolyte cathode of the previous study, where different parameters affect the performance of the cathodes.

Voltage and power generation in SCMFCS with activated sludge addition. Consistent with the previous results obtained by testing the cathode materials under the relatively “clean” conditions of uninoculated PBS, testing of the 3 cathode materials in SCMFCs with an activated sludge feed, including potentially catalyst-poisoning wastewater contaminants, demonstrated superior performance by the Fe-AAPyr cathode SCMFC, including more stable current production over 16 days. These SCMFCs were operated in a sequencing batch mode, with the activated sludge/PBS feed mixture completely replaced every 4 days and under a fixed external resistance of 470 Ω. During the first cycle Fe-AAPyr generated a stable voltage of 412±7 mV (308±6 μA cm⁻² or 124±3 μW cm⁻²), while the Pt and AC cathodes generated voltages of 375±7 mV (276.6±5.7 μA cm⁻² or 113.2±3.2 μW cm⁻²) and 350±12 mV (257.2±9.1 μA cm⁻² or 105.1±4.7 μW cm⁻²), respectively. The SCMFC with Fe-AAPyr catalyst generated a voltage that was 11% higher than that of the SCMFC with Pt-based cathode and 21% greater than the AC cathode system. The SCMFCs with Fe-AAPyr and AC cathodes demonstrated almost unchanged performance over the 4 cycles (16 days), while the SCMFC with the Pt cathodes had a decreasing voltage trend over time, to less than 350 mV by the 4^{th} cycle, which was also lower than the performance of the AC-based SCMFC.

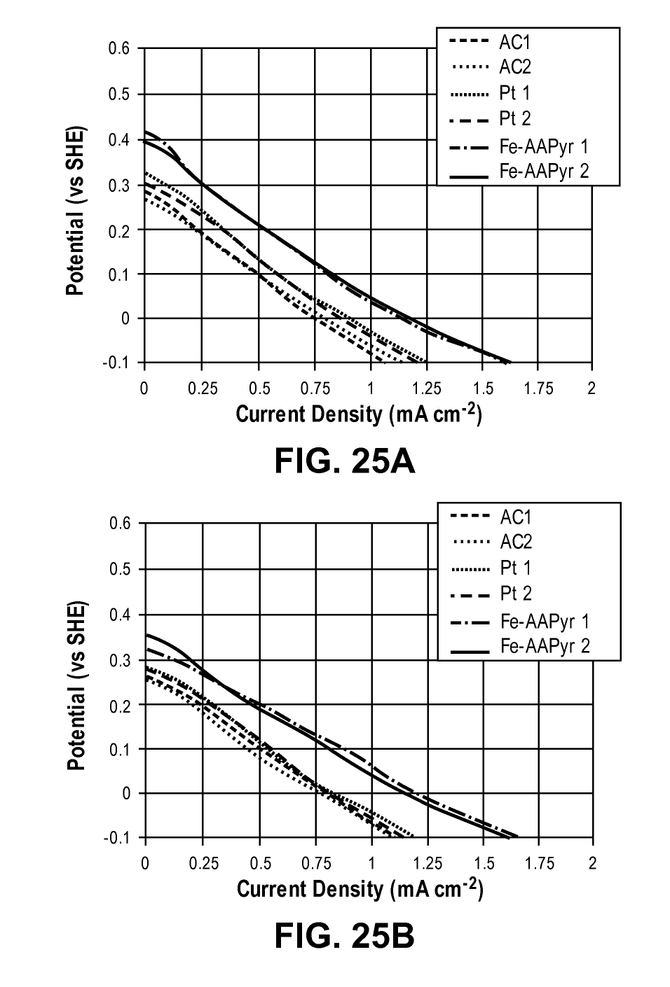

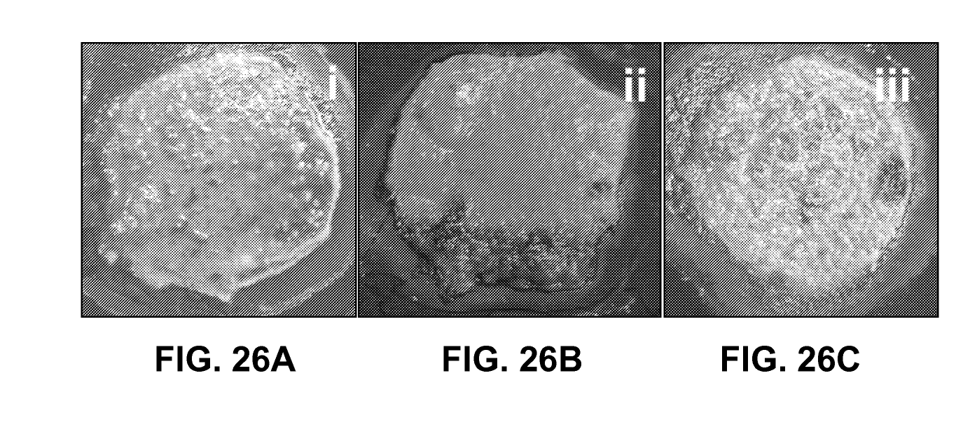

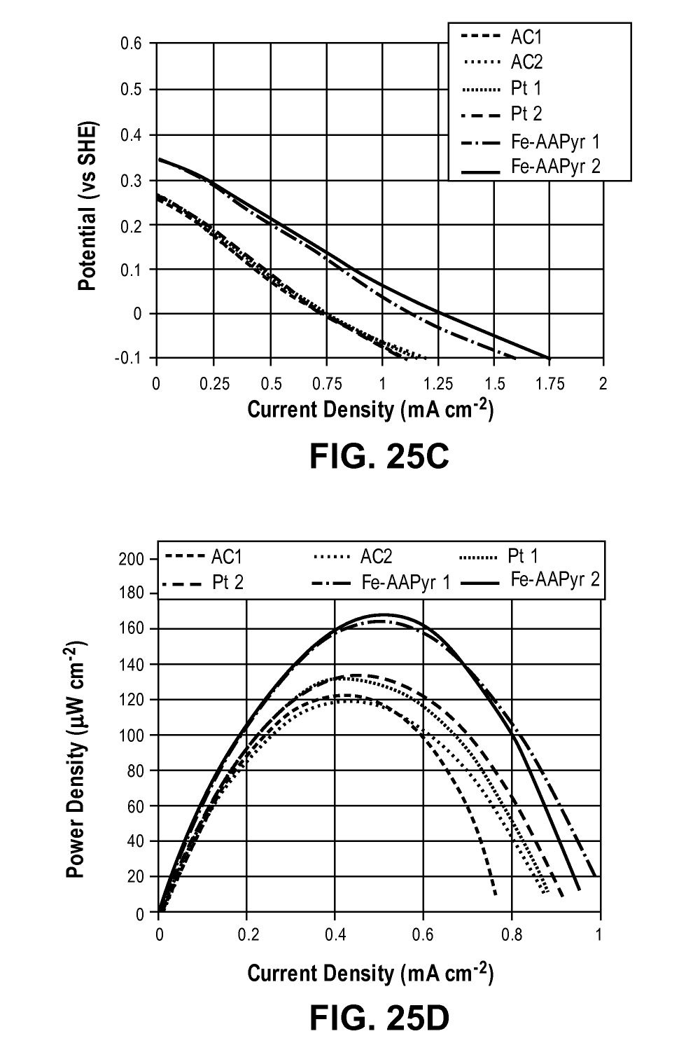

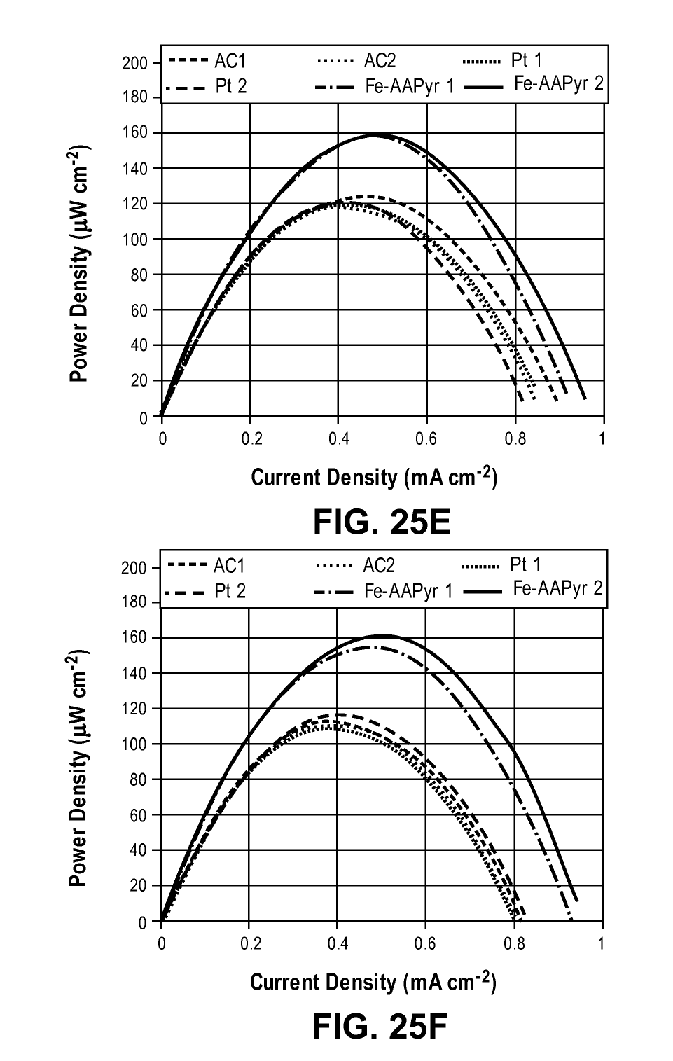

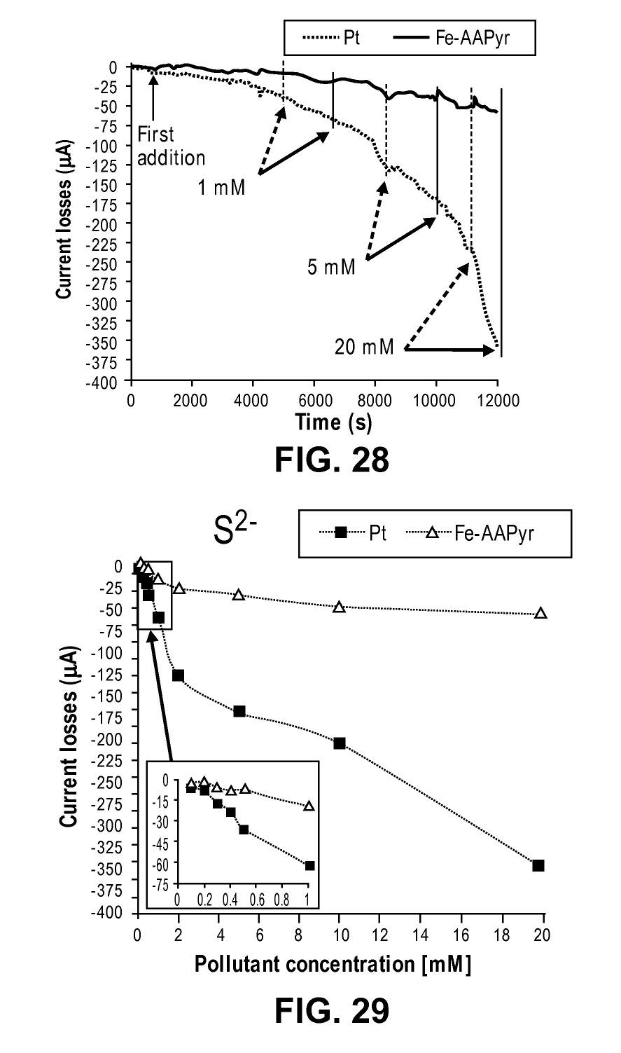

The results from intermediate single electrode polarization curves obtained by LSV on the SCMFC's cathodes during the 16 days study (FIG. 25a-25f were consistent with the overall performances of the systems. For example, at day 5 (2^{nd} cycle), Fe-AAPyr had a substantially higher electrocatalytic activity in comparison to the Pt and AC cathodes (FIG. 25, graphs a and d), while the Pt cathode had slightly higher activity than the AC cathode, which was consistent with the day 5 results shown in FIG. 28. Comparison of the results from FIG. 25a and FIG. 24 indicates that after 5 days of operation in activated sludge, the Pt activity decreased over time, from slightly lower than Fe-AAPyr at day 1 to slightly higher than AC at day 5. At days 9 and 13, the Pt and AC cathodes' activities were identical. Both the Fe-AAPyr and AC cathodes had relatively stable electrocatalytic activity during the experiment, showing advantages in long-term durability. These results are consistent with previous work showing that Pt loses activity during long-term operation (1 year) in a microbial fuel cell with PBS alone and without real wastewater or activated sludge. See e.g., Zhang, X., Pant, D. Zhang, F., Liu, J. & Logan, B. E. Long-term performance of chemically and physically modified activated carbons in microbial fuel cell air-cathodes. ChemElectroChem 1, 1859-1866 (2014). Even faster degradation in platinum performance was observed with the introduction of activated sludge into the electrolyte. See e.g, Santoro, C., Stadlhofer, A., Hacker, V., Squadrito, G., Schroder, U. & Li, B. Activated carbon nanofibers (ACNF) as cathode for single chamber microbial fuel cells (SCMFCs). J. Power Sources 243, 499-507 (2013). The results shown in FIGS. 25-27 suggest that the Fe-AAPyr cathode may provide the advantages of Pt in terms of high rates of activity, and those of AC in terms of high durability.

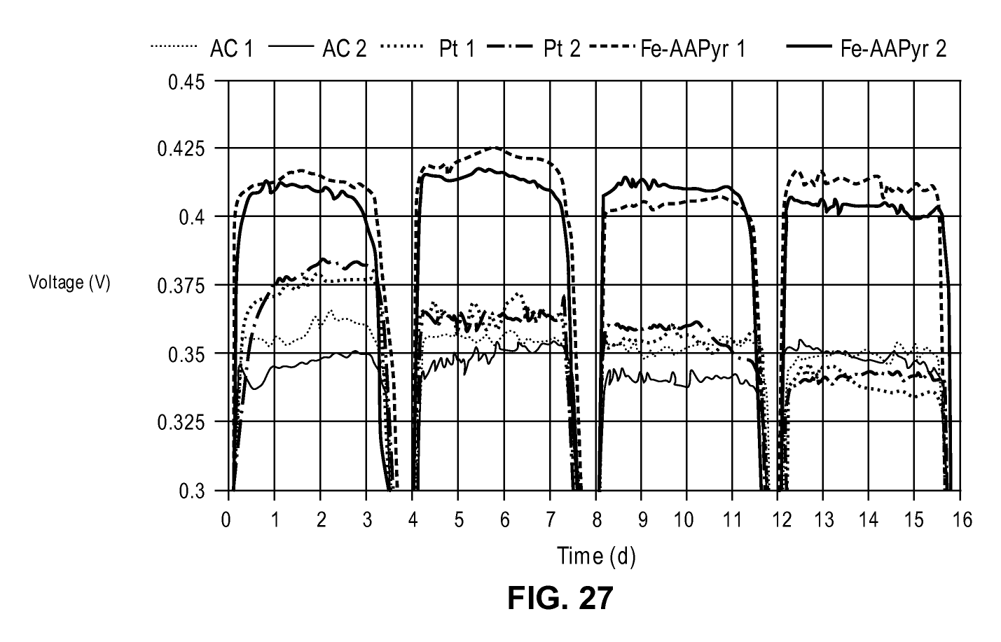

Similarly, power density measurements (FIGS. 25d, 25e, 25f) were generally consistent with the cell voltage (FIG. 27) and the single electrode polarizations (FIGS. 25a, 25b, 25c). The maximum power density observed for the SCMFC with Fe-AAPyr cathode was 167±6 μW cm⁻² (day 5), 159±3 μW cm⁻² (day 9) and 158±8 μW cm⁻² (day 13). The maximum power observed from SCMFC with the Pt-cathode was 134±4 μW cm⁻² (day 5), 118±4 μW cm⁻² (day 9) and 113±4 μW cm⁻² (day 13), demonstrating a marked decrease from day 5 to day 9. The power densities of the Pt-based cathode SCMFC on days 5 and 9 were similar to those of the AC cathode SCMFC. The power of the AC cathodes MFC remained stable around 117±11 μW cm⁻² throughout the entire test and is comparable to previously reported values obtained under similar working conditions. (Santoro, C. et al, Bioresour.Technol. 163, 54-63 (2014); Li, B. et al., Electrochim. Acta 134, 116-126 (2014).) The deactivation of the Pt catalyst in a short period of time underlined the low efficiency of platinum in “dirty” working conditions.

Biofilm presence on the Cathode. After 16 days, the SCMFCs were dismantled, and the cathodes were inspected. Biofilms were clearly visible on the cathode surfaces facing the waste solutions on all three cathodes types (FIGS. 26a, 26b, 26c). Generally, biofilm formation has been considered a negative factor for the final output, but in this case, the AC and Fe-AAPyr cathodes did not suffer from any decrease in generated power despite the biofilm developed. The relatively stable performance of the AC and Fe-AAPyr cathodes suggests that the biofilms did not significantly reduce the cathode's performance by increasing the resistance of electron or mass transfer. The decrease in Pt-cathode current may be due to catalyst inactivation by pollutants present in the activated sludge.

Poisoning Tests. Several common wastewater constituents are known to decrease Pt electrocatalytic activity, such as sulfide and sulfate ion (See, e.g., Sethuraman, V. A. & Weidner, J. W. Analysis of Sulfur Poisoning on a PEM Fuel Cell Electrode. Electrochim. Acta 55, 5683-5694 (2010); Regalbuto, J. Catalyst Preparation: Science and Engineering (CRC Press, Taylor & Francis Group, Boca Raton, Fla., 2007); and Spivey, J. J. Catalysis Volume 9 (The Royal Society of Chemistry, Cambridge, UK, 1992). However, little is known about how such compounds affect Fe-AAPyr activity.

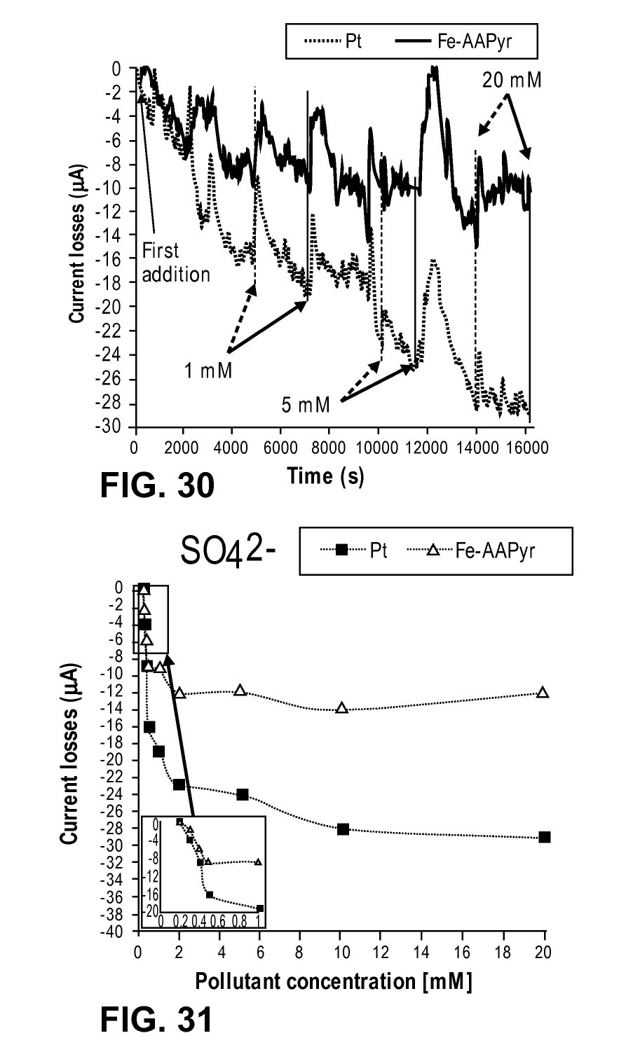

Chronoamperometry measurements of the cathodes at 0 V vs. Ag/AgCl were performed with variable amounts of the sulfide and sulfate ions to monitor the decrease in the ORR current as a result of the pollutants' inhibition effect. Data were normalized to the initial current in order to underline the current losses over time. FIG. 28 shows the current-time dependence of the tested cathodes as a response to various concentrations of S²⁻. The presence of S²⁻ decreased the activities of both cathodes, with a dramatically higher impact on the Pt-based electrode. Pt cathode lost roughly 36 μA, 170 μA and 345 μA at S²⁻ concentrations of 0.5 mM, 2 mM and 20 mM (FIG. 30 and FIG. 29). The effect of S²⁻ on Fe-AAPyr cathode performance was much lower, roughly 7 μA, 36 μA and 57 μA at the same S²⁻ concentration of 0.5 mM, 2 mM and 20 mM, respectively. The addition of 20 mM S²⁻ led to a decrease in current that was 6 times lower using Fe-AAPyr compared to Pt (57 μA and 345 μA respectively) showing that Fe-AAPyr catalyst is more tolerant to S²⁻. The effects of SO₄²⁻ (FIGS. 30 and 31) were lower in terms of current losses for both of the cathodes tested. At 20 mM SO₄²⁻ concentration, Pt lost roughly 30 μA while Fe-AAPyr lost only 13 μA. With both chemical species, Fe-AAPyr was more resistant to deactivation than Pt, consistent with the data above, supporting the practical use of this catalyst in “severe” conditions typical for MFCs treating wastewater.

Effect of Pollutants on Catalyst Surface Chemistry. X-ray Photoelectron Spectroscopy was used to estimate the changes that occur during exposure of the electrocatalysts to S²⁻ and SO₄²⁻ (Table 1). Elemental composition shows that for both of the types of catalysts, there is an increase in overall carbon and loss in F and S, especially for the electrolyte containing S²⁻. The changes in the ionomer-catalyst interaction in the cathodes were evaluated from the chemical speciation of sulfur, fluorine and carbon before and after the exposure to the deactivating chemicals.

TABLE 1
Effect of Pollutants on Catalyst Surface Chemistry

| | | | | | | 284-285 | | | 293-295 |
|---|---|---|---|---|---|---|---|---|---|
| | | | | | | C—C/ | 286-288 | 290-292 | CxFY |
| Sample | C % | O % | F % | S % | Pt % | C═C | CxOy | CFx | Oz |
| Pt BOL | 41.7 | 5.5 | 52.0 | 0.67 | 0.08 | 28.9 | 5.4 | 65.6 | |
| Pt S²⁻ | 51.1 | 3.4 | 45.5 | 0.19 | 0.00 | 39.8 | 11.4 | 19.8 | 28.9 |
| Pt SO₄²⁻ | 50.7 | 5.9 | 43.2 | 0.46 | 0.07 | 40.4 | 10.2 | 37.2 | 12.2 |
| | | | | | | C—C/ | | | CxFY |
| | C % | O % | F % | S % | N % | C═C | CxOy | CFx | Oz |
| FeAAPyr BOL | 38.4 | 5.5 | 54.9 | 0.59 | 0.71 | 13.0 | 8.4 | 78.6 | |
| FeAAPyr S²⁻ | 46.2 | 2.8 | 50.9 | 0.16 | 0.05 | 41.1 | 8.6 | 34.4 | 16.0 |
| FeAAPyr SO₄²⁻ | 44.3 | 4.8 | 50.1 | 0.47 | 0.55 | 62.6 | 11.1 | 24.0 | 2.3 |

| | 164.3 | 166.7 | 169.2 | 171.6 | 688. 7 | 690.3 | 692. 2 | 693.8 |
|---|---|---|---|---|---|---|---|---|
| Sample | S—C | S—O | SO₃ | CF₃—S | C—F | CF₂ | CxFyOz | |
| Pt BOL | | | 72.7 | 27.3 | 88.4 | 11.6 | | |
| Pt S²⁻ | 59.3 | 16.9 | 19.1 | 4.7 | 8.7 | 15.1 | 26.1 | 50.1 |
| Pt SO₄²⁻ | 3.6 | 1.6 | 61.5 | 33.4 | 23.7 | 37.5 | 29.7 | 9.2 |
| FeAAPyr BOL | | | 62.4 | 37.6 | 73.7 | 26.3 | | |
| FeAAPyr S²⁻ | 52.4 | 14.5 | 21.3 | 11.8 | 13.5 | 21.6 | 31.8 | 33.1 |
| FeAAPyr SO₄²⁻ | 39.7 | 4.4 | 44.9 | 11.0 | 45.1 | 18.3 | 22.6 | 14.0 |

In beginning-of-life (BOL) Pt and Fe-AAPyr samples, S 2p as two types of chemical environments specific to the ionomer used (Nafion®) at 169.2 and 171.6 eV. After the exposure to pollutants, two new peaks were detected in S 2p spectra, which were identified as sulfur coordinated to carbon (164. eV) and sulfur coordinated to oxygen (166.7 eV) pointing towards deterioration of the ionomer and disruption of the ionomer-catalyst interaction. For Pt-based electrocatalysts, a very small change in sulfur speciation was observed after SO₄²⁻ exposure, and this correlates well with the small losses in performance for this type of pollutant in comparison to S²⁻ treatment. Overall chemical changes introduced in S speciation of Fe-AAPyr catalysts were similar to those observed in platinum, while the performance losses for Fe-AAPyr were much smaller than for Pt. Thus the presence of S²⁻ in the electrolyte causes large deterioration of the ionomer composition in both Pt and Fe-AAPyr catalyst layers, but Fe-AAPyr catalysts still retained their activity in a higher degree than Pt electrocatalysts did.

The type of fluorine that is present in the ionomer can add more insight into pollutant action, as fluorine itself is not part of the pollutant as sulfur is, and it is not being introduced during exposure to the solutions. Both Pt and Fe-AAPyr BOL catalysts had similar fluorine composition with C-F (688.7 eV) and CF2 (690.3 eV) as expected for Nafion. During testing, oxidation of the CFₓ chains of the ionomer occurs, resulting in two new peaks identified as CxFyOz at higher binding energy of 692-694 eV. Larger chemical changes in the fluorine environment of the ionomer are observed for the Pt-based cathode than for Fe-AAPyr, which is correlated with larger losses in the performance for Pt-based electrocatalyst.

In C 1s speciation, oxidation changes of species that are present in the ionomer are evident. The largest change in a carbon environment is the decrease in the amount of CFx species that are present in the ionomer. This is accompanied by an increase of graphitic carbon and the formation of new peaks at higher binding energy of 293-295 eV due to the oxidation of CFx species. These changes in carbon environment are the largest for the Pt-based cathode. The smallest performance losses observed in sulfate are correlated with smallest oxidative changes in the carbon environment.

What is claimed is:

1. A bioelectric system comprising:
an anode comprising bacteria capable of oxidizing a reactant;
a cathode with an oxygen reduction reaction (ORR) catalyst, wherein the ORR catalyst is a metal-nitrogen-carbon catalyst and wherein the metal is a non-platinum group metal.

2. The bioelectric system of claim 1 wherein the ORR catalyst comprises a catalytic material having a highly developed three-dimensional open-frame structure.

3. The bioelectric system of claim 2 wherein the highly developed three-dimensional structure is at least partially the result of the removal of sacrificial particles.

4. The bioelectric system of claim 1 wherein the ORR comprises a metal that is selected from the group consisting of Fe, Co, Mn, Zn, Ce, Cr, Cu, Mo, Ni, Ru, Ta, Ti, V, W, and Zr.

5. The bioelectric system of claim 1 wherein the ORR catalyst comprises at least one of aminoantipyrine (AAPyr), mebendazole, carbendiazim, nicarbazi, phenanthroline, phenylenediamine, and PEI.

6. The bioelectric system of claim 1 wherein the cathode is in contact with the reactant.

7. The bioelectric system of claim 1 wherein the reactant is wastewater.

8. The bioelectric system of claim 7 wherein the cathode is in contact with the reactant.

9. The bioelectric system of claim 7 wherein the wastewater contains sulfur.

10. The bioelectric system of claim 9 wherein the ORR catalyst comprises AAPyr or MBZ and Fe.

11. The bioelectric system of claim 1 wherein the activity of the ORR catalyst increases or remains level as the environmental pH increases.

12. A method for treating wastewater comprising;
exposing the wastewater to a bioelectric system comprising:
an anode comprising bacteria capable of oxidizing a reactant in the wastewater; and
a cathode with an oxygen reduction reaction (ORR) catalyst, wherein the ORR catalyst is a metal-nitrogen-carbon catalyst having a highly developed three-dimensional open-frame structure and wherein the metal is a non platinum group metal;
such that the anode oxidizes reactants within the wastewater to produce electrons and protons and wherein the cathode reduces oxygen in the presence of the protons to produce H₂O.

13. The method of claim 12 wherein the ORR catalyst comprises at least one of aminoantipyrine (AAPyr), mebendazole, carbendiazim, nicarbazin, phenanthroline, phenylenediamine, or polyethyleneiemine.

14. The method of claim 13 wherein the ORR catalyst comprises a metal that is selected from the group consisting of Fe, Co, Mn, Zn, Ce, Cr, Cu, Mo, Ni, Ru, Ta, Ti, V, W, and Zr.

15. The method of claim 12 wherein the ORR catalyst has a highly developed three-dimensional open-frame structure.

16. The method of claim 15 wherein the ORR catalyst comprises AApyr or MBZ and Fe.

17. The method of claim 12 wherein the cathode is in direct contact with the wastewater.

18. The method of claim 12 further comprising using the electrons to provide power.

19. An ORR cathode for a bioelectric system comprising a metal-nitrogen-carbon catalytic material with surface chemical functionalization tailored to encourage oxygen adsorption and reduction while reducing undesired adsorption of materials such as sulfur or metals.

20. The cathode of claim 19 wherein the catalytic material consists of iron and AApyr or MBZ media comprises wastewater.
